(19) United States
(12) Patent Application Publication
(10) Pub. No.: US 2023/0027880 A1
(43) Pub. Date: Jan. 26, 2023

(54) TECHNIQUES FOR AUTOMATED TESTING OF APPLICATION PROGRAMMING INTERFACES

(71) Applicant: Infor (US), LLC, New York, NY (US)

(72) Inventor: Jeffrey Allen Brown, Colorado Springs, CO (US)

(21) Appl. No.: 17/383,001

(22) Filed: Jul. 22, 2021

(51) Int. Cl. G06F 11/36

(52) U.S. Cl. CPC G06F 11/3688; G06F 11/3684

(57) ABSTRACT

Various embodiments of the present invention provide methods, apparatuses, systems, computing devices, computing entities, and/or the like for executing efficient and reliable techniques for testing application programming interfaces (APIs) by utilizing at least one of API endpoint modeling data entities and workflow design user interfaces that are generated based at least in part on API endpoint modeling data entities.

### BACKGROUND

Various embodiments of the present invention address technical challenges related to multi-tenant automated software testing and make substantial technical improvements to improving the computational efficiency and operational reliability of test automation platforms. Various embodiments of the present invention makes important technical contributions to the operational reliability of software applications that are tested using the software application platforms.

### BRIEF SUMMARY

In general, embodiments of the present invention provide methods, apparatuses, systems, computing devices, computing entities, and/or the like for executing efficient and reliable techniques for testing application programming interfaces (APIs) by utilizing at least one of API endpoint modeling data entities and workflow design user interfaces that are generated based at least in part on API endpoint modeling data entities.

In accordance with one aspect, a method is provided. In one embodiment, the method comprises: identifying an API design data entity for an API, wherein the API design data entity describes a plurality of API endpoint documentation elements for the API endpoint; for each API endpoint documentation element, generating a modeling parameter set, wherein the modeling parameter set for the corresponding API endpoint documentation element comprises one or more constraint parameters for the corresponding API endpoint documentation element that define one or more constraints for a user-entered value set for the corresponding API endpoint documentation element; generating an API endpoint model data entity that describes the plurality of API endpoint documentation elements and a modeling parameter set for each API endpoint documentation element; and providing access to the API endpoint model data entity, wherein the API endpoint model data entity enables performance of one or more software testing operations using an automated testing workflow data entity associated with the API endpoint.

In accordance with another aspect, a computer program product is provided. The computer program product may comprise at least one computer-readable storage medium having computer-readable program code portions stored therein, the computer-readable program code portions comprising executable portions configured to: identify an API design data entity for an API, wherein the API design data entity describes a plurality of API endpoint documentation elements for the API endpoint; for each API endpoint documentation element, generate a modeling parameter set, wherein the modeling parameter set for the corresponding API endpoint documentation element comprises one or more constraint parameters for the corresponding API endpoint documentation element that define one or more constraints for a user-entered value set for the corresponding API endpoint documentation element; generate an API endpoint model data entity that describes the plurality of API endpoint documentation elements and a modeling parameter set for each API endpoint documentation element; and provide access to the API endpoint model data entity, wherein the API endpoint model data entity enables performance of one or more software testing operations using an automated testing workflow data entity associated with the API endpoint.

In accordance with yet another aspect, an apparatus comprising at least one processor and at least one memory including computer program code is provided. In one embodiment, the at least one memory and the computer program code may be configured to, with the processor, cause the apparatus to: identify an API design data entity for an API, wherein the API design data entity describes a plurality of API endpoint documentation elements for the API endpoint; for each API endpoint documentation element, generate a modeling parameter set, wherein the modeling parameter set for the corresponding API endpoint documentation element comprises one or more constraint parameters for the corresponding API endpoint documentation element that define one or more constraints for a user-entered value set for the corresponding API endpoint documentation element; generate an API endpoint model data entity that describes the plurality of API endpoint documentation elements and a modeling parameter set for each API endpoint documentation element; and provide access to the API endpoint model data entity, wherein the API endpoint model data entity enables performance of one or more software testing operations using an automated testing workflow data entity associated with the API endpoint.

In accordance with one aspect, a method is provided. In one embodiment, the method comprises: identifying an API endpoint model data entity for an API endpoint; generating user interface data for one or more workflow design user interfaces, wherein: (i) the one or more workflow design user interfaces describe, for each API documentation element in a defined subset of the plurality of API endpoint documentation elements, constraint guidance data describing one or more constraints for a user-entered value set for the API endpoint documentation element, and (ii) the one or more workflow design user interfaces enable an end user to provide each user-entered value set for an API endpoint documentation element in the defined subset; generating the automated testing workflow data entity based at least in part on each user-entered value set; and providing access to the automated testing workflow data entity, wherein the automated testing workflow data entity enables performance of one or more software testing operations.

In accordance with another aspect, a computer program product is provided. The computer program product may comprise at least one computer-readable storage medium having computer-readable program code portions stored therein, the computer-readable program code portions comprising executable portions configured to: identify an API endpoint model data entity for an API endpoint; generate user interface data for one or more workflow design user interfaces, wherein: (i) the one or more workflow design user interfaces describe, for each API documentation element in a defined subset of the plurality of API endpoint documentation elements, constraint guidance data describing one or more constraints for a user-entered value set for the API endpoint documentation element, and (ii) the one or more workflow design user interfaces enable an end user to provide each user-entered value set for an API endpoint documentation element in the defined subset; generate the automated testing workflow data entity based at least in part on each user-entered value set; and provide access to the automated testing workflow data entity, wherein the automated testing workflow data entity enables performance of one or more software testing operations.

In accordance with yet another aspect, an apparatus comprising at least one processor and at least one memory including computer program code is provided. In one embodiment, the at least one memory and the computer program code may be configured to, with the processor, cause the apparatus to: identify an API endpoint model data entity for an API endpoint; generate user interface data for one or more workflow design user interfaces, wherein: (i) the one or more workflow design user interfaces describe, for each API documentation element in a defined subset of the plurality of API endpoint documentation elements, constraint guidance data describing one or more constraints for a user-entered value set for the API endpoint documentation element, and (ii) the one or more workflow design user interfaces enable an end user to provide each user-entered value set for an API endpoint documentation element in the defined subset; generate the automated testing workflow data entity based at least in part on each user-entered value set; and provide access to the automated testing workflow data entity, wherein the automated testing workflow data entity enables performance of one or more software testing operations.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of a system that can be used to practice embodiments of the present invention;

FIG. 2 provides an example web server computing entity in accordance with some embodiments discussed herein;

FIG. 3 provides an example client computing entity in accordance with some embodiments discussed herein;

FIG. 4 is a flowchart diagram of an example process for performing automated testing of an API endpoint of an API in accordance with some embodiments discussed herein;

FIG. 5 is a flowchart diagram of an example process for generating an API design data entity for an API in accordance with some embodiments discussed herein;

FIG. 6 is a flowchart diagram of an example process for generating an API endpoint modeling data entity for an API endpoint of an API in accordance with some embodiments discussed herein;

FIG. 7 is a flowchart diagram of an example process for generating an automated testing workflow data entity for an API endpoint of an API in accordance with some embodiments discussed herein;

FIGS. 8A-8L provide operational examples of obtaining user-provided data for an API design data entity and an API endpoint modeling data entity in accordance with some embodiments discussed herein;

FIGS. 9A-9G provide operational examples of obtaining user-provided data for modeling parameter sets of API endpoint documentation elements of an API endpoint in accordance with some embodiments discussed herein; and

FIGS. 10A-10C provide operational examples of obtaining user-provided data for generating an automated testing workflow data entity using workflow design user interfaces that are generated based at least in part on an API endpoint modeling data entity of an API endpoint in accordance with some embodiments discussed herein.

### DETAILED DESCRIPTION

Various embodiments of the present invention are described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### Overview and Technical Advantages

Various embodiments of the present invention provide techniques for decoupling API test modeling from generating automated testing workflow design for API testing. For example, various embodiments of the present invention enable generating API endpoint model data entities and using the API endpoint model data entities to generate workflow design user interfaces that in turn enable a user to provide user values sets needed to generate automated testing workflow data entities for API endpoints. Decoupling API test modeling from generating automated testing workflow design for API testing enables more targeted and more resilient API testing, as it enables a test planner to generate constraints for testing that are required to be obeyed as well as general instructions for testing that may be ignored/modified at runtime. In this way, decoupling API test modeling from generating automated testing workflow design for API testing gives an important degree of flexibility to test planners in integrating runtime limits/considerations when formulating how to approach API testing operations. The result is more resilient, more traceable, and more flexible API testing approaches that in turn leads to better API testing, which eliminates/reduces the need for repeated and wasted API testing operations through reducing the number of erroneous software testing operations.

In some embodiments, by reducing the number of erroneous testing operations by decoupling API test modeling from generating automated testing workflow design for API testing, various embodiments of the present invention improve the operational efficiency of test automation platforms by reducing the number of processing operations that need to be executed by the noted test automation platforms in order to enable software testing operations (e.g., automated software testing operations). By reducing the number of processing operations that need to be executed by the noted test automation platforms in order to execute software testing operations, various embodiments of the present invention make important technical contributions to the field of software application testing. Accordingly, by enhancing the accuracy and reliability of automated testing workflow data entities generated by software testing engineers, the user-friendly and intuitive automated testing workflow generation techniques described herein improve the operational reliability of software application frameworks that are validated using the improved software testing operations described herein. By enhancing the operational reliability of software application frameworks that are validated using the improved software testing operations described herein, various embodiments of the present invention make important technical contributions to the field of software application framework.

### Definitions of Certain Terms

The term “API endpoint” may refer to a data entity that describes a single defined unit of functionality provided by an API. Depending on how an API is organized, different functionalities may be defined as parts of different functionality units and thus API endpoints, or alternatively they may be defined as parts of a single functionality unit and thus an API endpoint. For example, in one API, separate API endpoints may be defined for getting user names and getting user addresses, while in another API there may be a single API endpoint for getting user data, with the requested data type (name type, address type, and/or the like) being defined by one or more API endpoint parameters of the single API endpoint. An API endpoint, thus, may be associated with a set of API endpoint parameters that categorize user-defined properties of an API endpoint call that are independent of a base URL of an API that is associated with the API endpoint. Examples of such API endpoint parameters include path parameters defined by components of a uniform resource locator (URL) for an API call that precede a query parameter delimiter signal, and query parameters defined by components of the URL that follow the query parameter delimiter string. For example, given the API endpoint call that is associated with the URL http://example.com/movies?title=hangover, movies may be an example of a path parameter and hangover is an example of a value for a title query parameter, where movies precedes the query parameter delimiter string ? while title succeeds the noted query parameter delimiter string. Other examples of API endpoint parameters include header parameters that are defined as key-value pairs by the header section of a Hyper-Text Transform Protocol (HTTP) packet, as well as body parameters that are defined by the body section of an HTTP request.

The term “API endpoint documentation element” may refer to a data entity that describes an element of an API endpoint call or an API endpoint response for an API endpoint call that can be assigned a user-provided value as part of defining testing documentation data for an API endpoint. In some embodiments, an API endpoint documentation element describes an API endpoint parameter or a parameter of an API response to an API call that returns at least one of the following: (i) data about whether the API call generated an error, and (ii) one or more target data items requested by the API call. Thus, examples of API endpoint documentation elements include API endpoint parameters, such as query parameters, path parameters, header parameters, and body parameters. However, API endpoint documentation elements may also include API response parameters that may describe dynamically-generated components of an API response, including status codes of an API response and data returned by an API response retrieved from a set of target databases as a result of an API call. One objective behind including API response parameters as part of API endpoint documentation elements in addition to API calls is because values returned by API responses are relevant to testing of API endpoints, and thus providing testing documentation data for the noted API response parameters may in some embodiments be critical for effective and reliable testing of API endpoints of an API.

The term “API design data entity” may refer to a data entity that describes one or more API endpoints of an API as well as one or more API endpoint documentation elements for each of the noted API endpoints. In some embodiments, to generate an API design data entity, a web server computing entity aggregates the API endpoint documentation elements for each API endpoint to generate the API design data entity. In some embodiments, the API design data entity is a structured document entity that describes associations between defined API endpoints and API endpoint documentation elements. In some embodiments, the API design document entity is a JSON data entity. The API design data entity may describe features related to various API endpoints of an API. In some embodiments, a web server computing entity may generate the API design data entity by: (i) providing a set of API design user interfaces that enable an end user to define a set of API endpoints for a defined API as well as a set of API endpoint documentation elements for each API endpoint; and (ii) generating the API design data entity by aggregating each set of API endpoint documentation elements for a defined API endpoint. In some embodiments, a web server computing entity generates an API design data entity based at least in part on an imported API documentation data entity (e.g., an imported API documentation data entity describing API endpoint documentation elements for each API endpoint of an API using OpenAPI specification, such as a Swagger file including a Swagger 2.0 file and a Swagger 3.0 file).

The term “modeling parameter” may refer to a data entity that is configured to describe a property of an API endpoint documentation element that defines the scope and manner of user entry of a value corresponding to an API endpoint documentation element when generating an automated testing workflow data entity for the corresponding API endpoint. For example, a requirement modeling parameter for an API documentation element may describe whether the end user is required to enter a value corresponding to an associated API endpoint documentation element when generating an automated testing workflow data entity for the corresponding API endpoint. Accordingly, in at least some embodiments, if an API endpoint documentation element is associated with an affirmative requirement parameter, the end user is required to enter a value corresponding to the API endpoint documentation element when generating an automated testing workflow data entity for the corresponding API endpoint, while a negative requirement parameter may indicate that the end user is not required to enter a value corresponding to the API endpoint documentation element when generating an automated testing workflow data entity for the corresponding API endpoint. As another example, a hide-out modeling parameter for an API documentation element may describe whether the end user is allowed to in access (e.g., either view data related to, or modify data related to, or both) a corresponding API endpoint documentation element when generating an automated testing workflow data entity for the corresponding API endpoint. Accordingly, in at least some embodiments, if an API endpoint documentation element is associated with an affirmative hide-out parameter, the end user is not allowed to access the API endpoint documentation element when generating an automated testing workflow data entity for the corresponding API endpoint, while a negative hide-out parameter may indicate that the end user is allowed access the API endpoint documentation element when generating an automated testing workflow data entity for the corresponding API endpoint. Other examples of modeling parameter include constraint parameters, data type parameter, entry type parameters, minimum value parameters, maximum value parameters, and null value allowance parameters. In some embodiments, the set of one or more modeling parameters for an API endpoint documentation element is referred to herein as a modeling parameter set for the API endpoint documentation element.

The term “constraint parameter” may refer to a data entity that describes a modeling parameter that defines allowed formats for a user-entered value set for a corresponding API endpoint documentation element, where the user-entered value set for an API endpoint documentation element describes user values presented as inputs and/or expected values for the API endpoint documentation element when generating an automated testing workflow data entity. Examples of constraint parameters include a data type parameter that describes the format of the data (e.g., string, datetime, integer, and/or the like) that an end user is allowed to enter for a corresponding API endpoint documentation element, an entry type parameter that describes a method of entry of data that an end user is allowed to use for a corresponding API endpoint documentation element, a maximum length parameter that describes a maximum length of the data that an end user is allowed to enter for a corresponding API endpoint documentation element, a minimum length parameter that describes a maximum length of the data that an end user is allowed to enter for a corresponding API endpoint documentation element, a pattern parameter that describes an overall alphanumeric pattern of the data that an end user is allowed to enter for a corresponding API endpoint documentation element, and a null value allowance parameter that describes whether an end user is allowed to enter null-valued data a maximum length parameter that describes a maximum length of the data that an end user is allowed to enter for a corresponding API endpoint documentation element.

The term “API endpoint model data entity” is a data entity that describes, for each API endpoint documentation element of a corresponding API endpoint, a modeling parameter set. In some embodiments, the API endpoint model data entity defines a hidden subset of the plurality of API endpoint documentation elements, wherein each API endpoint documentation element in the hidden subset is associated with a modeling parameter set comprising an affirmative hide-out parameter. In some embodiments, the API endpoint model data entity defines a required subset of the plurality of API endpoint documentation elements, wherein each API endpoint documentation element in the required subset is associated with a modeling parameter set comprising an affirmative requirement parameter. In some embodiments, the API endpoint model data entity is used to enable user interaction with a set of workflow design user interfaces that enable an end user to provide user value sets, where the user value sets are in turn used to generate an automated testing workflow data entity for a corresponding API endpoint documentation element. In some embodiments, a web server computing entity generates user interface data for one or more workflow design user interfaces, wherein: (i) the one or more workflow design user interfaces describe, for each API documentation element in a defined subset of the plurality of API endpoint documentation elements, constraint guidance data describing the one or more constraints for the user-entered value set for the API endpoint documentation element, and (ii) the one or more workflow design user interfaces enable an end user to provide each user-entered value set for an API endpoint documentation element in the defined subset. In some of the noted embodiments, the one or more workflow design user interfaces enable an end user to provide each user-entered value set based at least in part on historical log data entries associated with a corresponding API endpoint documentation element. In some of the noted embodiments, the API endpoint model data entity defines a hidden subset of the plurality of API endpoint documentation elements, wherein each API endpoint documentation element in the hidden subset is associated with a modeling parameter set comprising an affirmative hide-out parameter; and the defined subset is determined based at least in part on the hidden subset. In some of the noted embodiments, the API endpoint model data entity defines a required subset of the plurality of API endpoint documentation elements, wherein each API endpoint documentation element in the required subset is associated with a modeling parameter set comprising an affirmative requirement parameter; and the one or more workflow design user interfaces require that the end-user provides each user-entered value set for an API endpoint documentation element in the required subset.

The term “automated testing workflow data entity” may refer to data entity that is configured to describe a sequence of web-based actions that may be executed to generate an automated testing operation associated with a software test that is configured to be executed to achieve a particular software testing objective, such as to exercise a particular program path or to verify compliance with a specific operational requirement. For example, the automated testing workflow data entity may describe a sequence of webpages (e.g., a sequence of webpages from multiple websites across multiple tabs with one or more sessions) associated with a software testing operation, where each webpage may in turn be associated with a set of automated testing workflow steps. The sequence of webpages and their associated automated testing workflow steps may then be used to generate automation scripts for the software testing operation, where the automation script may be executed by an execution agent in order to execute the software testing operation and generate a software testing output based at least in part on a result of the execution of the automation script. In some embodiments, an automates testing workflow data entity describes a series of API endpoint calls that may be used to test an API. In some embodiments, to generate an automated testing workflow data entity, a web server computing entity generates user interface data for one or more workflow design user interfaces, wherein: (i) the one or more workflow design user interfaces describe, for each API documentation element in a defined subset of the plurality of API endpoint documentation elements, constraint guidance data describing the one or more constraints for the user-entered value set for the API endpoint documentation element, and (ii) the one or more workflow design user interfaces enable an end user to provide each user-entered value set for an API endpoint documentation element in the defined subset. In some of the noted embodiments, the one or more workflow design user interfaces enable an end user to provide each user-entered value set based at least in part on historical log data entries associated with a corresponding API endpoint documentation element. In some of the noted embodiments, the API endpoint model data entity defines a hidden subset of the plurality of API endpoint documentation elements, wherein each API endpoint documentation element in the hidden subset is associated with a modeling parameter set comprising an affirmative hide-out parameter; and the defined subset is determined based at least in part on the hidden subset. In some of the noted embodiments, the API endpoint model data entity defines a required subset of the plurality of API endpoint documentation elements, wherein each API endpoint documentation element in the required subset is associated with a modeling parameter set comprising an affirmative requirement parameter; and the one or more workflow design user interfaces require that the end-user provides each user-entered value set for an API endpoint documentation element in the required subset. In some embodiments, generating the automated testing workflow data entity based at least in part on each user-entered value set comprises generating each automated testing workflow step of the automated testing workflow data entity based at least in part on a user-entered value in the user-entered value set. In some embodiments, automated execution of an automated testing workflow data entity is performed using at least one of an execution plan data entity and an execution run data entity.

The term “execution plan data entity” may refer to a data construct that is configured to describe a collection of API endpoint model data entities. For example, an execution plan data entity may describe a set of API endpoint model data entities that are generated based at least in part on a set of execution plan definition tags. In some embodiments, when an execution plan data entity is determined based at least in part on a set of API endpoint model data entities that are generated based at least in part on set of execution plan definition tags, the execution plan data entity may be referred to herein as a “dynamic execution plan data entity.” As another example, an execution plan data entity may describe a set of API endpoint model data entities that are explicitly selected by an end user of a web server computing entity. In some embodiments, when an execution plan data entity describes a set of API endpoint model data entities that are explicitly selected by an end user of a web server computing entity, the execution plan data entity may be referred to herein as a “static execution plan data entity.”

The term “execution run data entity” may refer to a data construct that is configured to describe a defined execution of an execution plan data entity, such as a defined automated execution of an execution plan data entity or a defined manual execution of an execution plan data entity. In some embodiments, when an execution run data entity describes an automated execution of an execution plan data entity, the execution run data entity is referred to herein as an “automated execution run data entity.” In some embodiments, when an execution run data entity describes a manual execution of an execution plan data entity, the execution run data entity is referred to herein as a “manual execution run data entity.” In some embodiments, an execution run data entity is determined based at least in part on a set of execution run definition parameters for the execution run data entity, such as an execution run automation parameter for the execution run data entity that describes whether the execution run data entity is an automated execution run data entity or a manual execution run data entity; an execution run scheduling parameter for the execution run data entity that describes whether the execution run data entity should be executed once, periodically (e.g., in accordance with a defined periodicity), or in an on-demand manner as demanded by end users; an execution run parallelization parameter for the execution run data entity that describes whether the execution run data entity should be performed sequentially or in parallel; and an execution run web environment parameter for the execution run data entity that describes the Uniform Resource Locator (URL) for a base (i.e., starting) webpage of the execution run data entity.

The term “automated testing workflow step” may refer to a data construct that is configured to describe a user action required by a software testing operation associated with a corresponding automated testing workflow data entity, where the user action may be executed with respect to an interactive page element of a webpage associated with a captured page image of the corresponding automated testing workflow data entity. In some embodiments, generating the automated testing workflow data entity based at least in part on each user-entered value set comprises generating each automated testing workflow step of the automated testing workflow data entity based at least in part on a user-entered value in the user-entered value set. In some embodiments, automated execution of an automated testing workflow data entity is performed using at least one of an execution plan data entity and an execution run data entity. In some embodiments, at least automated testing workflow step is selected from historical automated testing workflow steps associated with the API.

### Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage median include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatuses, systems, computing devices, computing entities, and/or the like. As such, embodiments of the present invention may take the form of an apparatus, system, computing device, computing entity, and/or the like executing instructions stored on a computer-readable storage medium to execute certain steps or operations. Thus, embodiments of the present invention may also take the form of an entirely hardware embodiment, an entirely computer program product embodiment, and/or an embodiment that comprises combination of computer program products and hardware executing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be executed sequentially such that one instruction is retrieved, loaded, and executed at a time. In some exemplary embodiments, retrieval, loading, and/or execution may be executed in parallel such that multiple instructions are retrieved, loaded, and/or executed together. Thus, such embodiments can produce specifically-configured machines executing the steps or operations specified in the block diagrams and flowchart illustrations. Accordingly, the block diagrams and flowchart illustrations support various combinations of embodiments for executing the specified instructions, operations, or steps.

### Exemplary System Framework

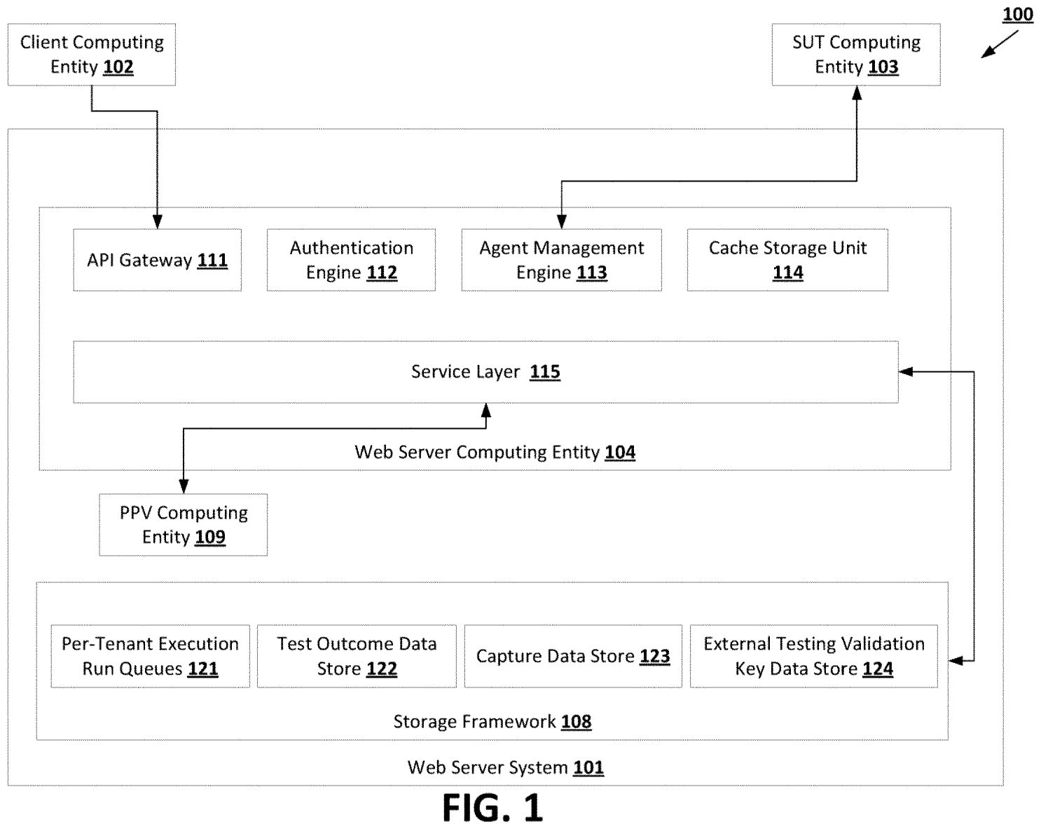

FIG. 1 depicts an architecture 100 for managing multi-tenant execution of a group of automated execution run data entities associated with a plurality of test automation tenants. The architecture 100 that is depicted in FIG. 1 includes the following: (i) a web server system 101 comprising a web server computing entity 104, a storage framework 108, and a post-production validation (PPV) computing entity 109; (ii) one or more client computing entities such as the client computing entity 102; and (iii) and one or more system under test (SUT) computing entities such as the SUT computing entity 103.

In some embodiments, the web server computing entity 104 is configured to: (i) receive execution run data entities from the client computing entities and execute software testing operations corresponding to the execution run data entities by interacting with the SUT computing entities 103; and (ii) validate software testing platforms by installing the software testing platforms on the PPV computing entity 109 and checking whether the installed software testing platforms comply with platform requirements (e.g., customer-specified platform requirements). The web server computing entity 104 may be configured to receive execution run data entities from the client computing entities using the application programming (API) gateway 111 that may be an Amazon API Gateway. The web server computing entity 104 may further be configured to validate execution run data entities using the Authentication Engine 112, which may be an Amazon Web Services (AWS) Lambda Authentication Filter. The web server computing entity 104 may be further configured to execute software testing operations corresponding to execution run data entities by using automated testing execution agents generated and maintained by an agent management engine 113, where the agent management engine 113 may be configured to generate and maintain automated testing execution agents based at least in part on autoscaling routines and agent throttling concepts discussed herein.

The web server computing entity 104 may be further configured to maintain a cache storage unit 114 (e.g., a Redis cache) to maintain execution data associated with executing software testing operations corresponding to the execution run data entities by interacting with the SUT computing entities 103 and/or execution data associated with validating software testing platforms by installing the software testing platforms on the PPV computing entity 109 and checking whether the installed software testing platforms comply with platform requirements (e.g., customer-specified platform requirements).

The web server computing entity 104 may in some embodiments comprise a service layer 115, where the service layer 115 is comprised to maintain at least one of the following in the storage framework 108: (i) a set of per-tenant execution run queues 121 (as further described below); (ii) a test outcome data store 122 storing data describing which software testing operations have succeeded or failed; (iii) a capture data store 123 storing data related to captured page images generated while performing software testing operations; and (iv) an external testing validation key data store 124 storing external testing validation keys for external automated testing execution agents.

### Exemplary Web Server Computing Entity

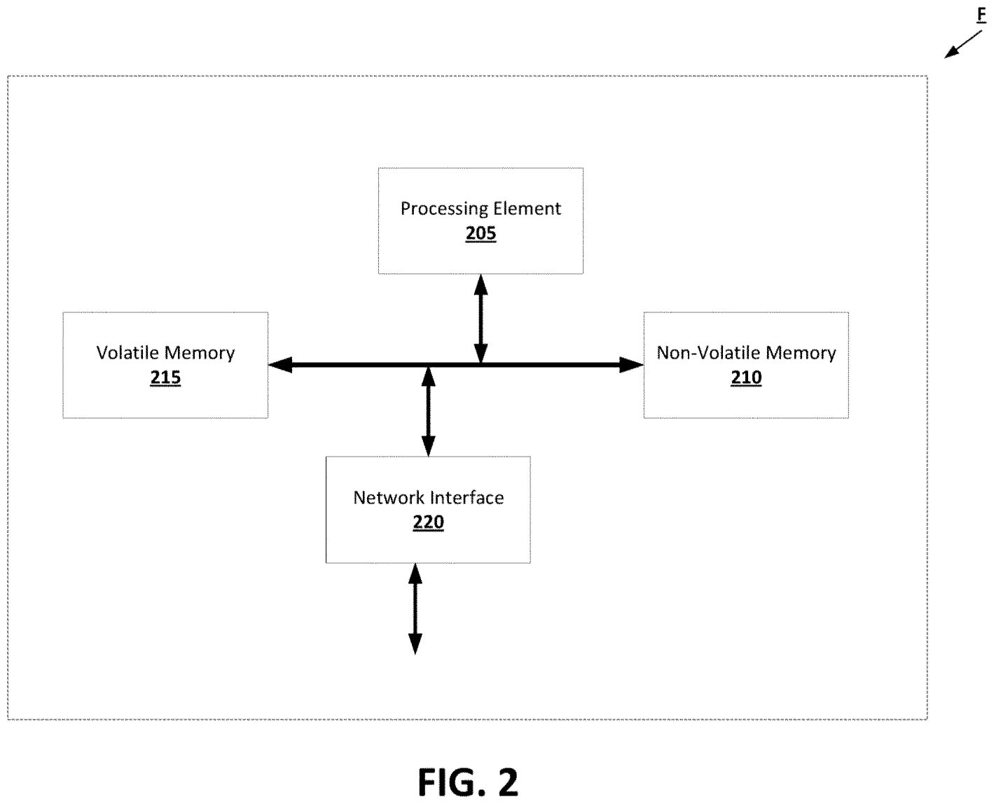

FIG. 2 provides a schematic of a web server computing entity 104 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to execute the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be executed on data, content, information, and/or similar terms used herein interchangeably. While FIG. 2 is described with reference to the web server computing entity 104, a person of ordinary skill in the relevant technology will recognize that the depicted architecture can be used in relation to SUT computing entities and PPV computing entities.

As indicated, in one embodiment, the web server computing entity 104 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the web server computing entity 104 may include, or be in communication with, one or more processing elements 205 (also referred to as processors, processing circuitry, and/or similar terms used herein interchangeably) that communicate with other elements within the web server computing entity 104 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of executing steps or operations according to embodiments of the present invention when configured accordingly.

In one embodiment, the web server computing entity 104 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity—relationship model, object model, document model, semantic model, graph model, and/or the like.

In one embodiment, the web server computing entity 104 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the web server computing entity 104 with the assistance of the processing element 205 and operating system.

As indicated, in one embodiment, the web server computing entity 104 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the web server computing entity 104 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the web server computing entity 104 may include, or be in communication with, one or more input elements, such as a keyboard input, a mouse input, a touch screen/display input, motion input, movement input, audio input, pointing device input, joystick input, keypad input, and/or the like. The web server computing entity 104 may also include, or be in communication with, one or more output elements (not shown), such as audio output, video output, screen/display output, motion output, movement output, and/or the like.

### Exemplary Client Computing Entity

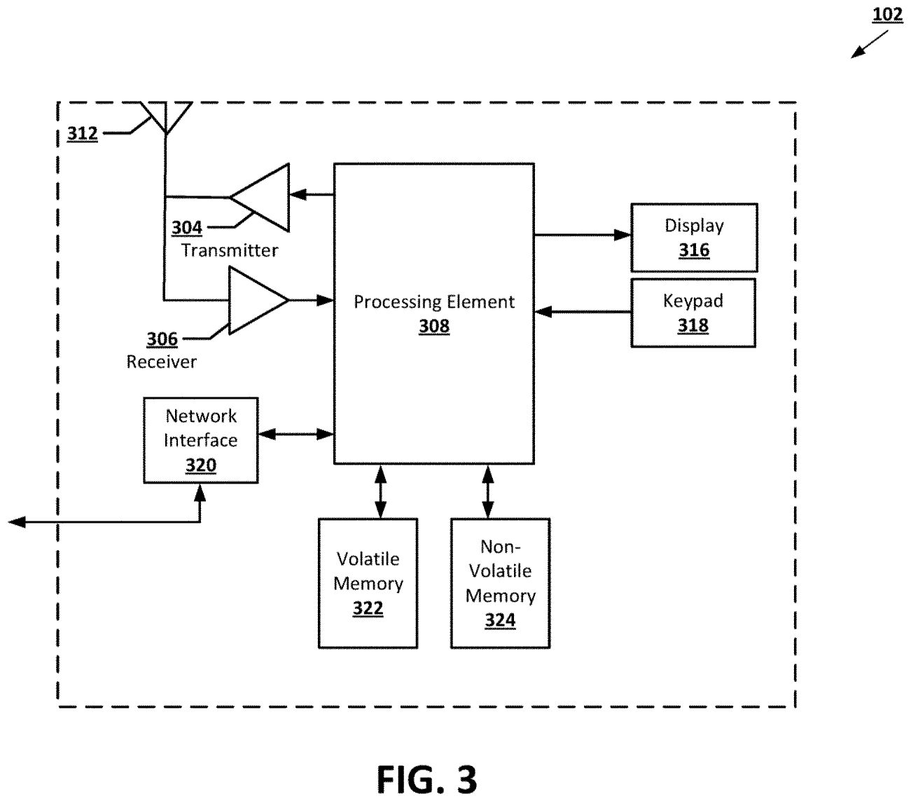

FIG. 3 provides an illustrative schematic representative of an client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the web server computing entity 104. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the web server computing entity 104 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the web server computing entity 104, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the web server computing entity 104 and/or various other computing entities.

In another embodiment, the client computing entity 102 may include one or more components or functionality that are the same or similar to those of the web server computing entity 104, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Exemplary System Operations

As described below, by reducing the number of erroneous testing operations by decoupling API test modeling from generating automated testing workflow design for API testing, various embodiments of the present invention improve the operational efficiency of test automation platforms by reducing the number of processing operations that need to be executed by the noted test automation platforms in order to enable software testing operations (e.g., automated software testing operations). By reducing the number of processing operations that need to be executed by the noted test automation platforms in order to execute software testing operations, various embodiments of the present invention make important technical contributions to the field of software application testing. Accordingly, by enhancing the accuracy and reliability of automated testing workflow data entities generated by software testing engineers, the user-friendly and intuitive automated testing workflow generation techniques described herein improve the operational reliability of software application frameworks that are validated using the improved software testing operations described herein. By enhancing the operational reliability of software application frameworks that are validated using the improved software testing operations described herein, various embodiments of the present invention make important technical contributions to the field of software application framework.

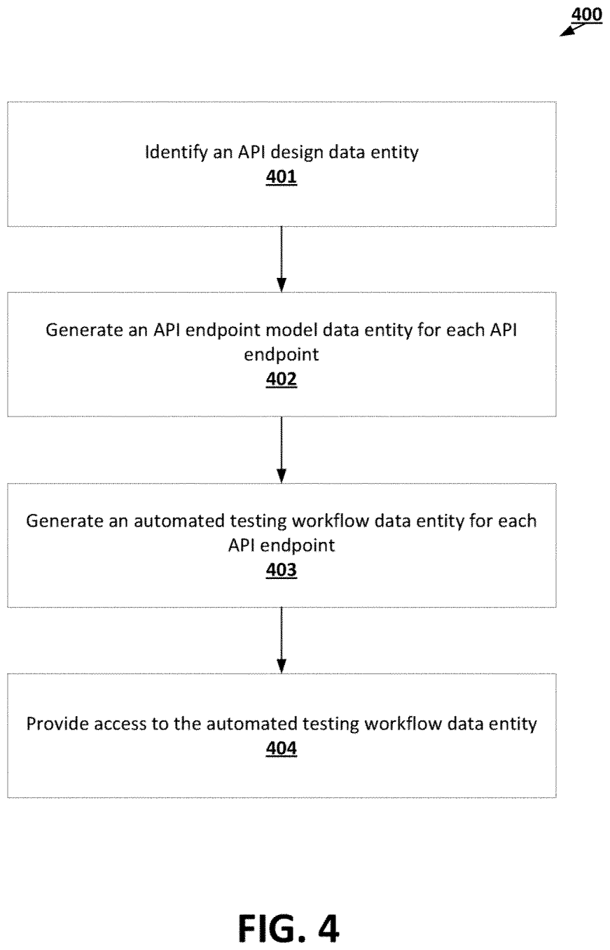

FIG. 4 is a flowchart diagram of an example process 400 for enabling automated testing of an API endpoint of an API. Via the various steps/operations of the process 400, the web server computing entity 104 can enable efficient and reliable automated testing of an API in a manner that decouples API design from API documentation design and API testing workflow design. A person of ordinary skill in the relevant technology will recognize that the process 400 can be performed with respect to each API endpoint of an API having multiple endpoints to enable holistic testing of various components of the noted API.

The process 400 begins at step/operation 401 when the web server computing entity 104 identifies (e.g., receives, generates, and/or the like) an API design data entity. The API design data entity may describe features related to various API endpoints of an API. In some embodiments, the web server computing entity 104 may generate the API design data entity by: (i) providing a set of API design user interfaces that enable an end user to define a set of API endpoints for a defined API as well as a set of API endpoint documentation elements for each API endpoint; and (ii) generating the API design data entity by aggregating each set of API endpoint documentation elements for a defined API endpoint. In some embodiments, the web server computing entity 104 generates an API design data entity based at least in part on an imported API documentation data entity (e.g., an imported API documentation data entity describing API endpoint documentation elements for each API endpoint of an API using OpenAPI specification (e.g., Request for Comments (RFCs) rfc1378, rfc2616, and rfc3986), such as a Swagger file including a Swagger 2.0 file and a Swagger 3.0 file).

In some embodiments, an API design data entity describes one or more API endpoints of an API as well as one or more API endpoint documentation elements for each of the noted API endpoints. In some embodiments, to generate an API design data entity, a web server computing entity aggregates the API endpoint documentation elements for each API endpoint to generate the API design data entity. In some embodiments, the API design data entity is a structured document entity that describes associations between defined API endpoints and API endpoint documentation elements. In some embodiments, the API design document entity is a JSON data entity. The API design data entity may describe features related to various API endpoints of an API. In some embodiments, a web server computing entity may generate the API design data entity by: (i) providing a set of API design user interfaces that enable an end user to define a set of API endpoints for a defined API as well as a set of API endpoint documentation elements for each API endpoint; and (ii) generating the API design data entity by aggregating each set of API endpoint documentation elements for a defined API endpoint. In some embodiments, a web server computing entity generates an API design data entity based at least in part on an imported API documentation data entity (e.g., an imported API documentation data entity describing API endpoint documentation elements for each API endpoint of an API using OpenAPI specification, such as a Swagger file including a Swagger 2.0 file and a Swagger 3.0 file).

An API endpoint may be a single defined unit of functionality provided by an API. Depending on how an API is organized, different functionalities may be defined as parts of different functionality units and thus API endpoints, or alternatively they may be defined as parts of a single functionality unit and thus an API endpoint. For example, in one API, separate API endpoints may be defined for getting user names and getting user addresses, while in another API there may be a single API endpoint for getting user data, with the requested data type (name type, address type, and/or the like) being defined by one or more API endpoint parameters of the single API endpoint. An API endpoint, thus, may be associated with a set of API endpoint parameters that categorize user-defined properties of an API endpoint call that are independent of a base URL of an API that is associated with the API endpoint. Examples of such API endpoint parameters include path parameters defined by components of a uniform resource locator (URL) for an API call that precede a query parameter delimiter signal, and query parameters defined by components of the URL that follow the query parameter delimiter string. For example, given the API endpoint call that is associated with the URL http://example.com/movies?title=hangover, movies may be an example of a path parameter and hangover is an example of a value for a title query parameter, where movies precedes the query parameter delimiter string ? while title succeeds the noted query parameter delimiter string. Other examples of API endpoint parameters include header parameters that are defined as key-value pairs by the header section of a Hyper-Text Transform Protocol (HTTP) packet, as well as body parameters that are defined by the body section of an HTTP request.

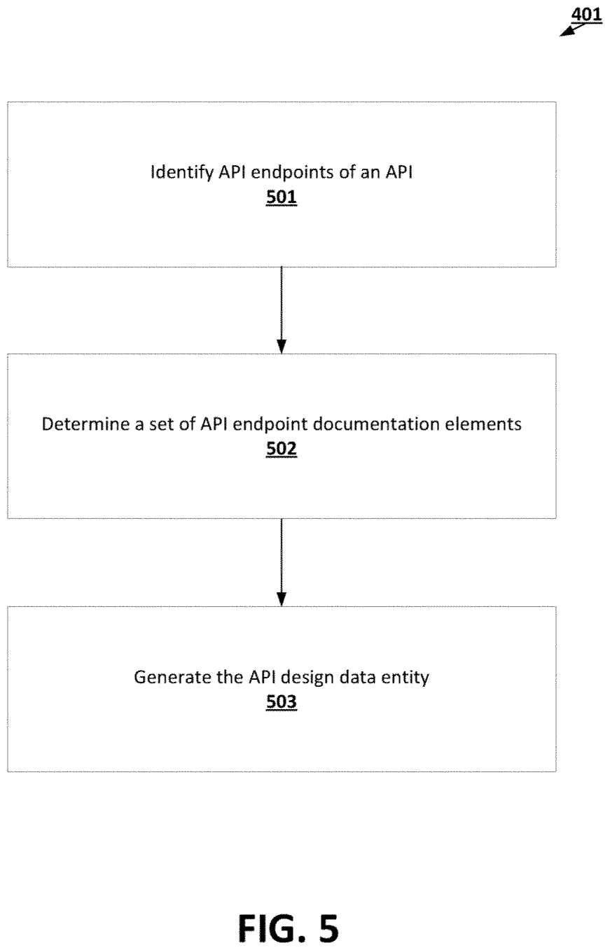

In some embodiments, step/operation 401 may be performed in accordance with the process that is depicted in FIG. 5. The process that is depicted in FIG. 5 begins at step/operation 501 when the web server computing entity 104 identifies one or more API endpoints of the API. For example, in some embodiments, the set of API design user interfaces include a set of API endpoint definition user interfaces that enable an end user to define API endpoints of a defined API. As another example, in some embodiments, the set of API design user interfaces include a set of API endpoint definition user interfaces that enable an end user to define API endpoints of a defined API.

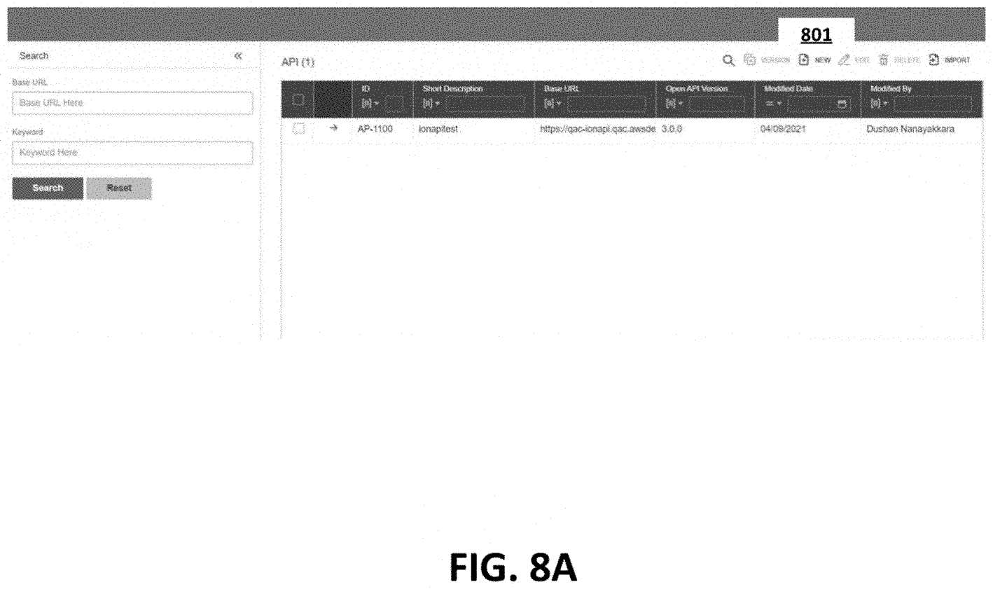

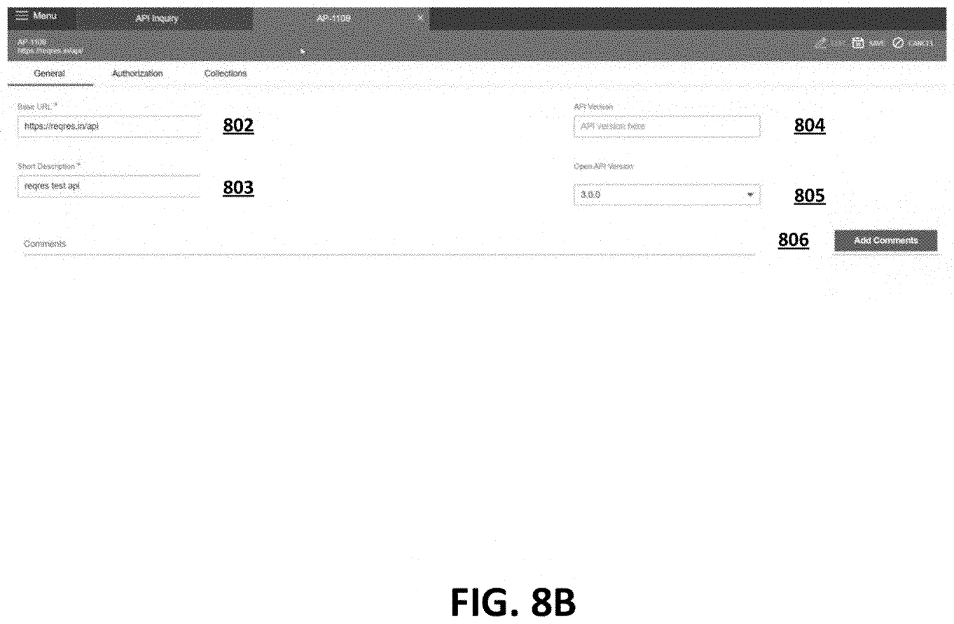

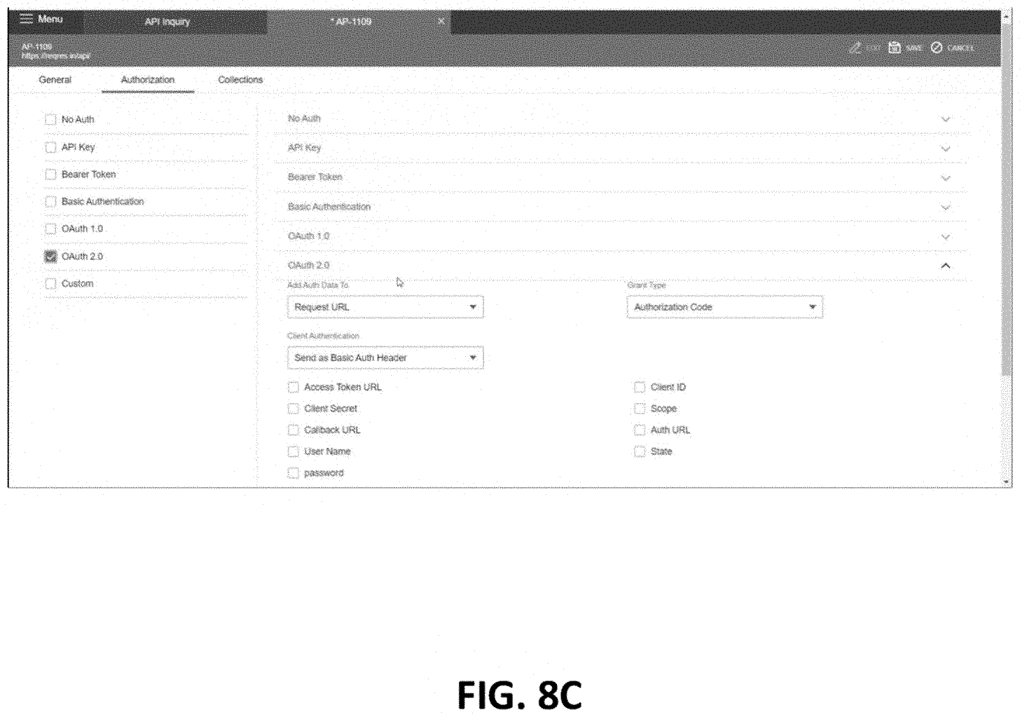

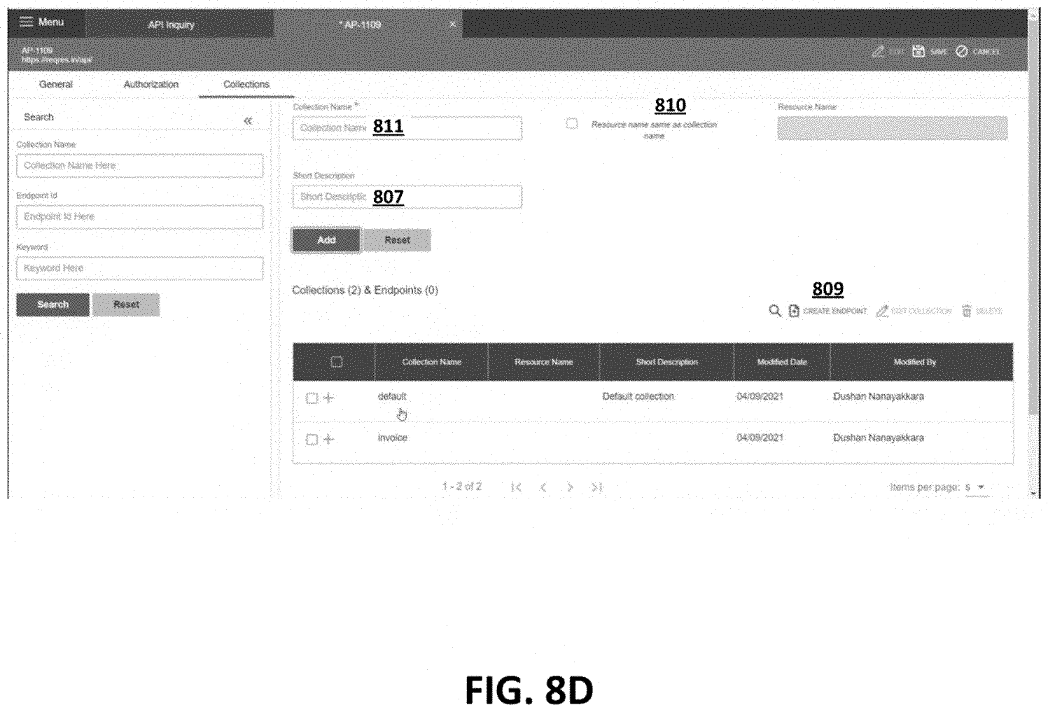

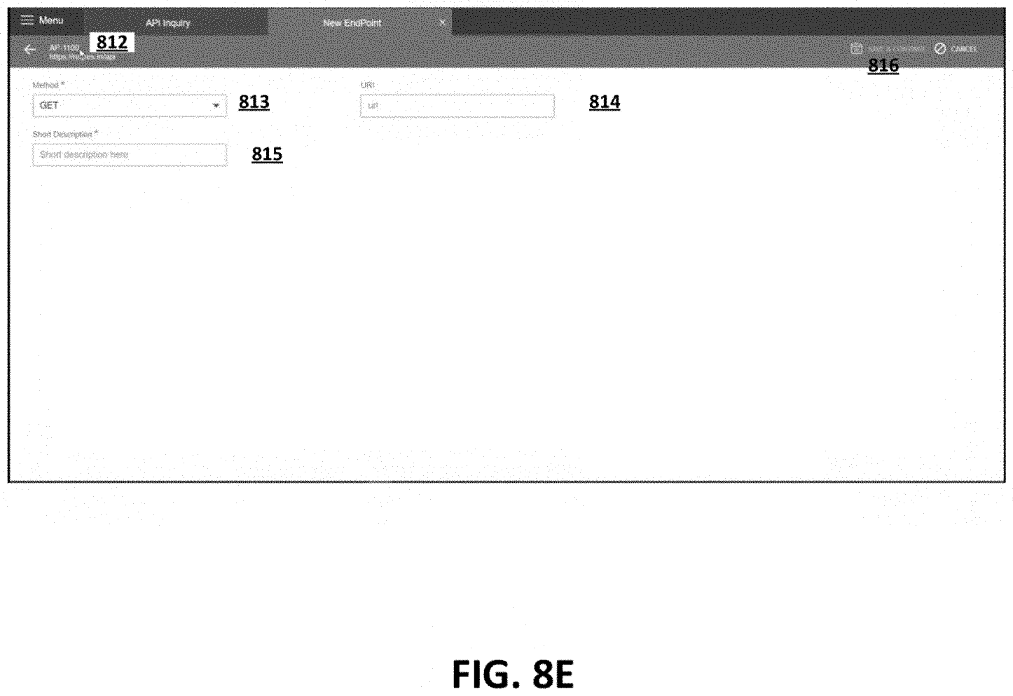

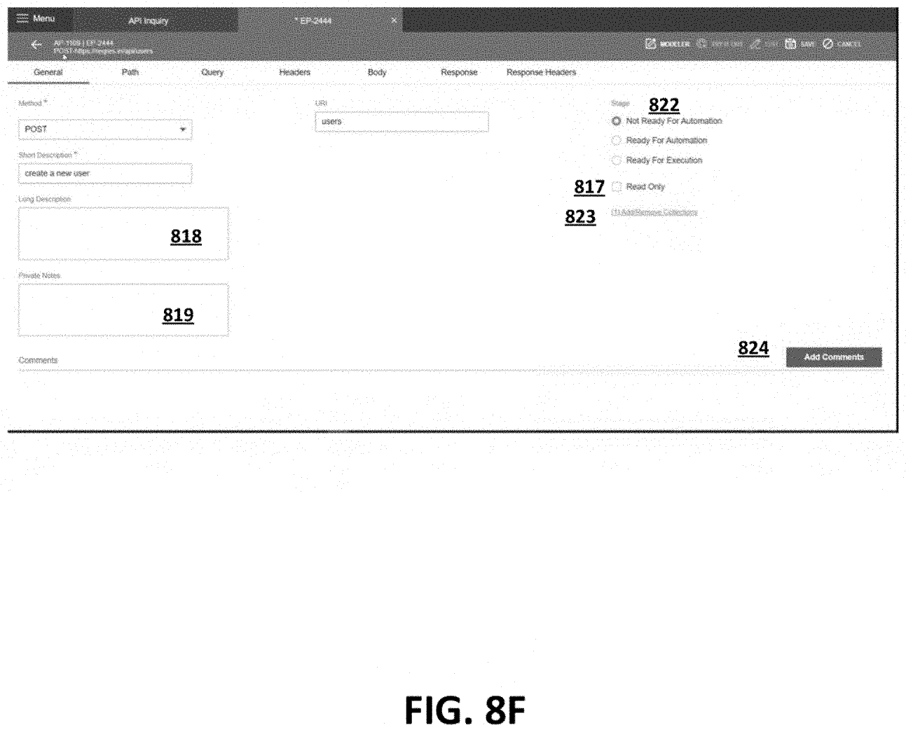

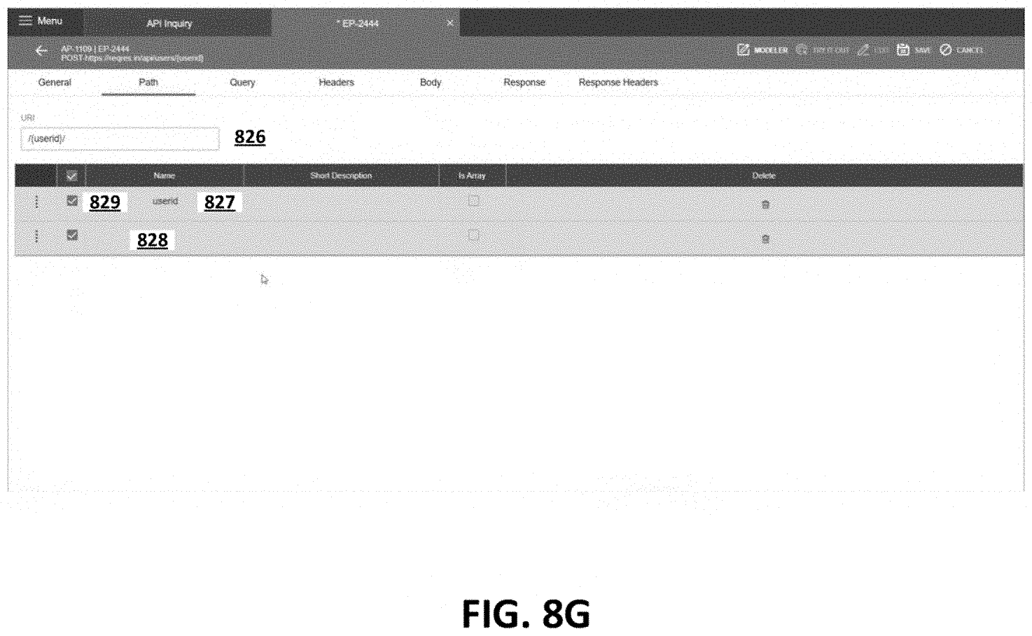

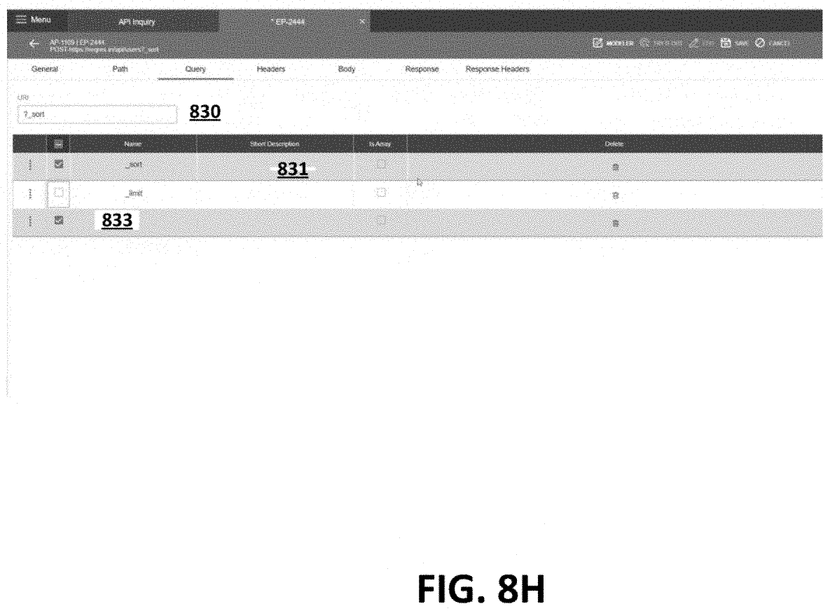

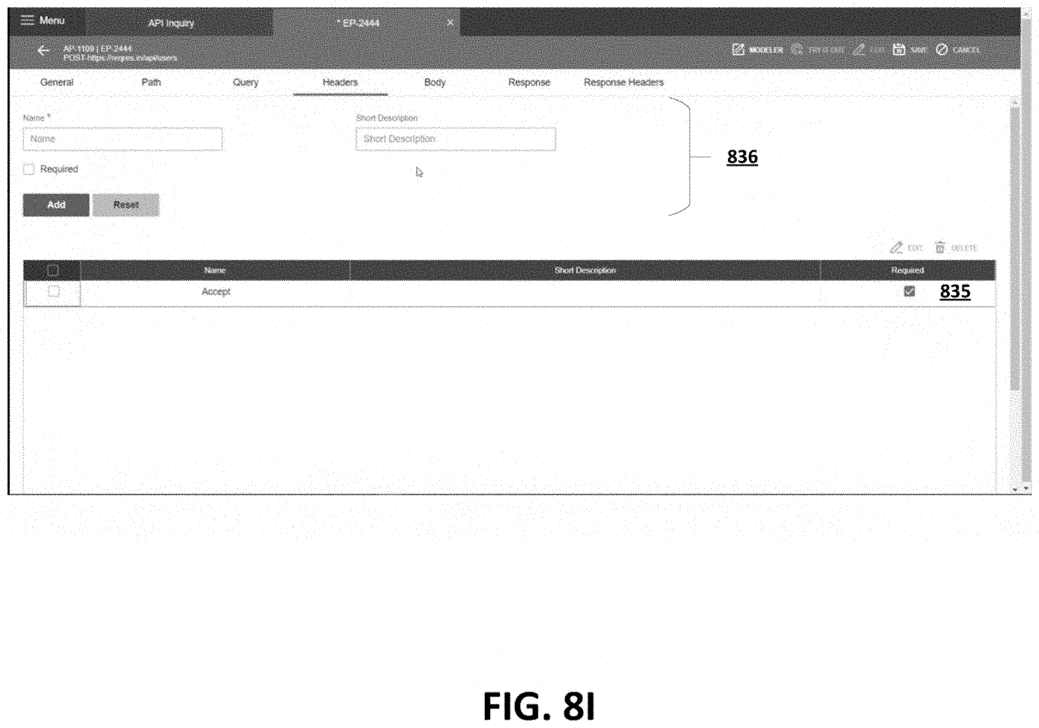

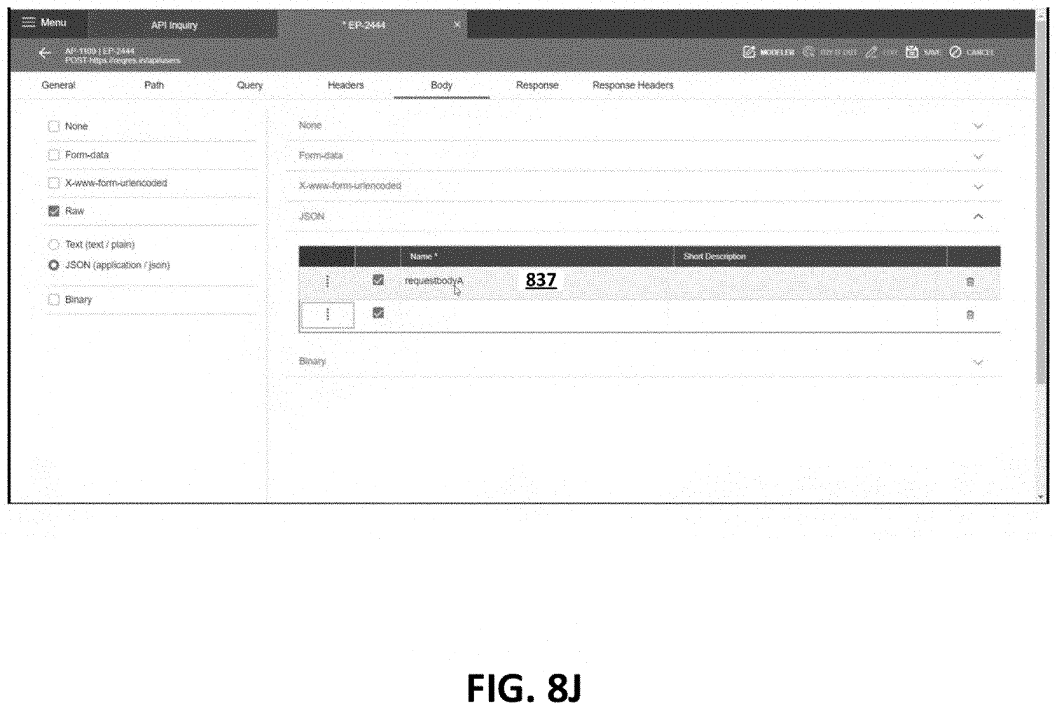

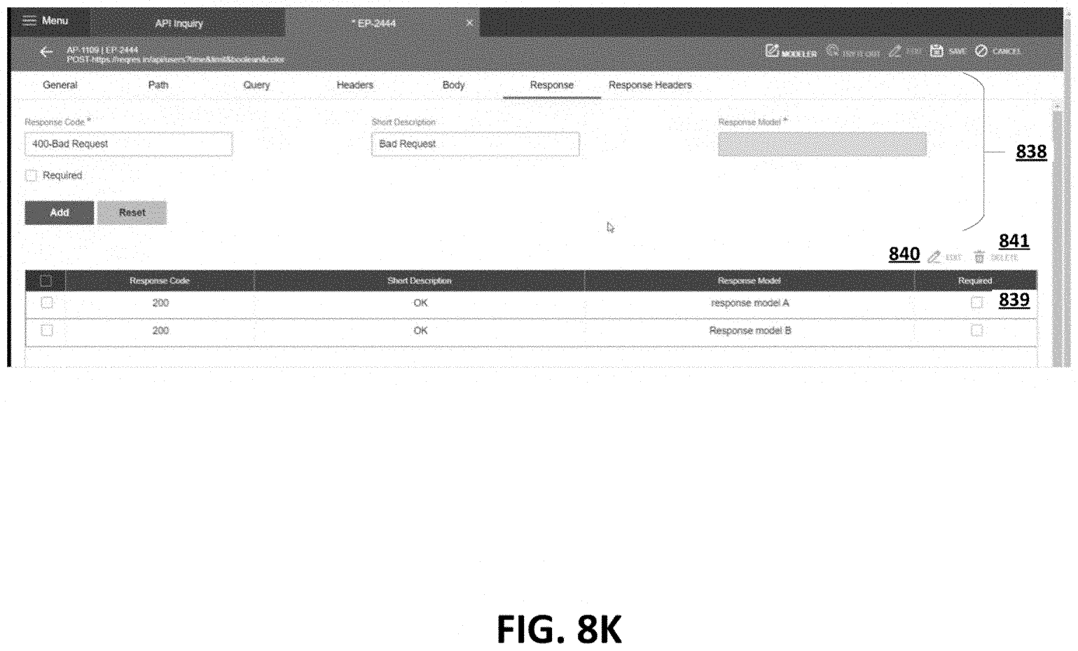

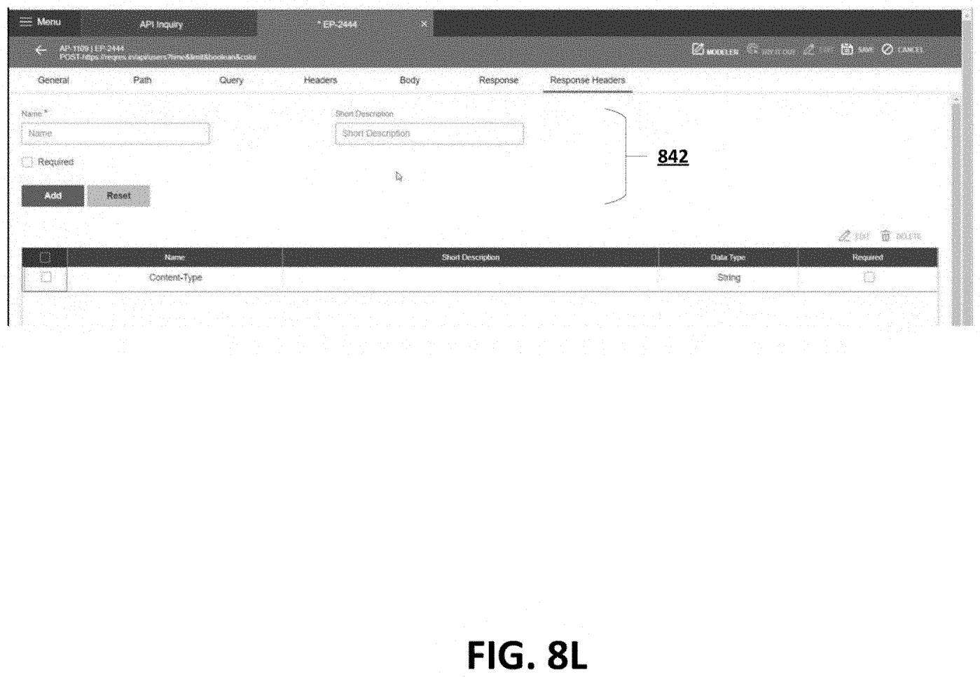

An operational example of a set of API endpoint design user interfaces that can be used to define one or more API endpoints of an API are depicted in FIGS. 8A-8F. In particular, the user interface of FIG. 8A enables initiating a process of defining an API by interacting with the user interface element 801, which leads to presentation of the user interface of FIG. 8B. The user interface of FIG. 8B enables user entry of general API definition parameters associated with a new API, including a base URL for the new API (which can be entered using the user interface element 802), a short description for the new API (which can be entered using the user interface element 803), an API version for the new API (which can be entered using the user interface element 804), an OpenAPI version for a version of the OpenAPI standard used in relation to the new API (which can be entered using the user interface element 805), and a set of user-provided comments for the new API (which can be entered using the user interface element 806).

Other API definition parameters for a new API can be defined using the user interfaces of FIGS. 8C-8D. In particular, the user interface of FIG. 8C enables user entry of API definition parameters that define authorization/authentication credentials needed for accessing the new API. Moreover, the user interface of FIG. 8D enables defining API endpoint collections associated with the new API, where an endpoint collection is a collection of one or more API endpoints. As depicted in FIG. 8D, each new API collection can be associated with a collection name (which can be entered using the user interface element 811), a short description (which can be entered using the user interface element 807), and a designator that enables providing the collection name of an endpoint collection as part of the resource name for API endpoints that are associated with the endpoint collection (where the noted designator can be entered using the user interface element 810). As further depicted in FIG. 8D, each new API endpoint can be defined either in relation to one or more defined endpoint collections (e.g., by selecting the target endpoint collections and clicking on the user interface element 809) or without any relation to any defined endpoint collections (e.g., by clicking on the user interface element 809 without selection of any target endpoint collections).

User selection of the user interface element 809 causes presentation of the user interface that is depicted in FIG. 8E, which enables defining API endpoint definition parameters associated with a new API endpoint. As depicted in FIG. 8E, the following API endpoint definition parameters may be entered: an API endpoint method type for the new API endpoint (which can be entered using the user interface element 813), an API endpoint uniform resource identifier (URI) for the new API endpoint (which can be entered using the user interface element 814), and a short description for the new API endpoint (which can be entered using the user interface element 815). FIG. 8E further depicts that the API endpoint is associated with a defined API whose alphanumeric designator and URL are depicted using the user interface element 812 of the depicted user interface.

FIG. 8F (which can be displayed after user selection of the user interface element 816 of FIG. 8E) enables defining additional API endpoint definition parameters for the new API endpoint, including a long description for the new API endpoint (which can be entered using the user interface element 818), private notes for the new API endpoint (which can be entered using the user interface element 819), an automation/execution readiness designation for the new API endpoint (which can be selected using the user interface element 822), a read-only designation for the new API endpoint (which can be selected using the user interface element 817), any endpoint collection associations for the new API endpoint (which can be modified using the user interface element 823), and any user-provided comments for the new API endpoint (which can be modified/entered using the user interface element 824).

Returning to FIG. 5, at step/operation 502, the web server computing entity 104 determines a set of API endpoint documentation elements for each API endpoint. Examples of API endpoint documentation elements for an API endpoint include query parameters for the API endpoint, path parameters for the API endpoint, header parameters for the API endpoint, body parameters for the API endpoint, and candidate response options for the API endpoint. In some embodiments, the API endpoint documentation elements may be defined by an end user using a set of API endpoint documentation element definition user interfaces.

Operational examples of API endpoint documentation element definition user interfaces that can be used to determine API endpoint documentation elements for an API endpoint are depicted in FIGS. 8G-8L. As depicted in FIG. 8G, a new path parameter can be created either by user interaction with the user interface element 826 and by using the syntax /{path-parameter-name}/, or alternatively by user interaction with a blank entry in the depicted table (e.g., the blank entry associated with the user interface element 828, which enables user entry of a path parameter name for a new path parameter). As further depicted in FIG. 8F, each path parameter may be associated with a name (which can be modified via user interaction with the user interface element 827), an isArray designation describing whether the path parameter is expected to receive an array input, and a designator describing whether the end user intends to use the path parameter in or exclude it from the API endpoint documentation elements for the API endpoint that are covered by the API design data entity (where the noted designator can be modified via user interaction with the user interface element 829).

As depicted in FIG. 8H, a new query parameter can be created either by user interaction with the user interface element 830 and by using the syntax ? query-parameter-name, or alternatively by user interaction with a blank entry in the depicted table (e.g., the blank entry associated with the user interface element 833, which enables user entry of a query parameter name for a new query parameter). As further depicted in FIG. 8H, each query parameter may be associated with a name (which can be modified via user interaction with a query parameter name), an isArray designation describing whether the query parameter is expected to receive an array input, a designator describing whether the end user intends to use the query parameter or exclude it from the API endpoint documentation elements for the API endpoint that are covered by the API design data entity (which can be modified via user interaction with the user interface element 829), and a short description for the query parameter (which can be modified via user interaction with an existing short description, such as the short description that is depicted in user interface element 831).

As depicted in FIG. 8I, a new header parameter for a defined API endpoint can be defined using the header parameter definition panel of the user interface element 836, which enables providing a name for a new header parameter, a short description for a new header parameter, and a designator describing whether the new header parameter should be deemed to be a required field of an API endpoint call associated with the corresponding API endpoint. The noted required designator for an existing header parameter may also be modified using checkbox user interface elements such as the user interface element 835.

As depicted in FIG. 8J, one or more body parameters for an API endpoint call can be defined using various formats, such as the JSON format that is selected in the operational example of FIG. 8J. As further depicted in FIG. 8J, once a format for an API endpoint call body is selected, body parameters, such as the body parameter that can be accessed using the user interface element 837, can be defined for the request model in accordance with the selected format for the body. FIG. 8J also depicts that each body parameter is associated with a modifiable name and a modifiable short description.

As depicted in FIG. 8K, one or more candidate response options for an API endpoint response can be created using the user interface element 838, which enables defining a response code for a new candidate response option, a short description for the new candidate response option, a response model for the new candidate response option, and a designator describing whether the candidate response option will be displayed to an end user when the end user provides inputs using a set of workflow design user interfaces in order to generate an API endpoint model data entity (as further described below). As further depicted in FIG. 8K, existing candidate response options may be selected and, once selected: (i) edited using the user interface element 840, (ii) deleted using the user interface element 841, and (iii) marked to be displayed to an end user when the end user provides inputs in order to generate an API endpoint model data entity, using checkbox user interface elements such as the user interface element 839.

As depicted in FIG. 8L, one or more response headers for an API endpoint call can be defined using the user interface element 842, which enables defining a name for a new response header, a short description for the new response header, and a designator describing whether the response header will be displayed to an end user when the end user provides inputs in order to generate an API endpoint model data entity (as further described below). As further depicted in FIG. 8L, an existing response header can be deleted or edited or marked as required to be displayed to an end user when the end user provides inputs in order to generate an API endpoint model data entity.

Accordingly, examples of API endpoint documentation element definition parameters include path parameter names (e.g., path parameters that may be defined/modified using the user interface of FIG. 8G), path parameter short descriptions (path parameter short descriptions that may be defined/modified using the user interface of FIG. 8G), path parameters isArray values (e.g., path parameters isArray values that may be defined/modified using the user interface of FIG. 8G), designators of path parameters that define whether path parameters will be displayed to an end user when the end user provides inputs in order to generate an API endpoint model data entity (e.g., as defined/modified using the user interface of FIG. 8G), query parameter names (e.g., query parameters that may be defined/modified using the user interface of FIG. 8H), query parameter short descriptions (query parameter short descriptions that may be defined/modified using the user interface of FIG. 8H), query parameters isArray values (e.g., query parameters isArray values that may be defined/modified using the user interface of FIG. 8H), designators of query parameters that define whether query parameters will be displayed to an end user when the end user provides inputs in order to generate an API endpoint model data entity (e.g., as defined/modified using the user interface of FIG. 8H), header parameter names (e.g., header parameters that may be defined/modified using the user interface of FIG. 8I), header parameter short descriptions (header parameter short descriptions that may be defined/modified using the user interface of FIG. 8I), designators of header parameters that define whether header parameters will be displayed to an end user when the end user provides inputs in order to generate an API endpoint model data entity (e.g., as defined/modified using the user interface of FIG. 8I), body parameter names (e.g., body parameters that may be defined/modified using the user interface of FIG. 8J), body parameter short descriptions (body parameter short descriptions that may be defined/modified using the user interface of FIG. 8J), designators of body parameters that define whether body parameters will be displayed to an end user when the end user provides inputs in order to generate an API endpoint model data entity (e.g., as defined/modified using the user interface of FIG. 8J), candidate response option response codes (e.g., candidate response option response codes that may be defined/modified using the user interface of FIG. 8K), candidate response option names (e.g., candidate response option names that may be defined/modified using the user interface of FIG. 8K), candidate response option short descriptions (e.g., candidate response option short descriptions that may be defined/modified using the user interface of FIG. 8K), candidate response option response models (e.g., candidate response option response models that may be defined/modified using the user interface of FIG. 8K), designators of candidate response options that define whether candidate response options will be displayed to an end user when the end user provides inputs in order to generate an API endpoint model data entity (e.g., as defined/modified using the user interface of FIG. 8K), response header names (e.g., response header names that may be defined/modified using the user interface of FIG. 8L), response header short descriptions (e.g., response header short descriptions that may be defined/modified using the user interface of FIG. 8L), response header data types (e.g., response header data types that may be defined/modified using the user interface of FIG. 8L), designators of response headers that define whether response headers will be displayed to an end user when the end user provides inputs in order to generate an API endpoint model data entity (e.g., as defined/modified using the user interface of FIG. 8L), and/or the like.

An API endpoint documentation element may be an element of an API endpoint call or an API endpoint response for an API endpoint call that can be assigned a user-provided value as part of defining testing documentation data for an API endpoint. In some embodiments, an API endpoint documentation element describes an API endpoint parameter or a parameter of an API response to an API call that returns at least one of the following: (i) data about whether the API call generated an error, and (ii) one or more target data items requested by the API call. Thus, examples of API endpoint documentation elements include API endpoint parameters, such as query parameters, path parameters, header parameters, and body parameters. However, API endpoint documentation elements may also include API response parameters that may describe dynamically-generated components of an API response, including status codes of an API response and data returned by an API response retrieved from a set of target databases as a result of an API call. One objective behind including API response parameters as part of API endpoint documentation elements in addition to API calls is because values returned by API responses are relevant to testing of API endpoints, and thus providing testing documentation data for the noted API response parameters may in some embodiments be critical for effective and reliable testing of API endpoints of an API.

Returning to FIG. 5, at step/operation 503, the web server computing entity 104 aggregates the API endpoint documentation elements for each API endpoint to generate the API design data entity. In some embodiments, the API design data entity is a structured document entity that describes associations between defined API endpoints and API endpoint documentation elements. In some embodiments, the API design document entity is a JSON data entity.

Returning to FIG. 4, at step/operation 402, the web server computing entity 104 generates an API endpoint model data entity for each API endpoint of the API. In some embodiments, an API endpoint model data entity describes, for each API endpoint documentation element of a corresponding API endpoint, a modeling parameter set that define one or more modeling parameters for the particular API endpoint documentation element.

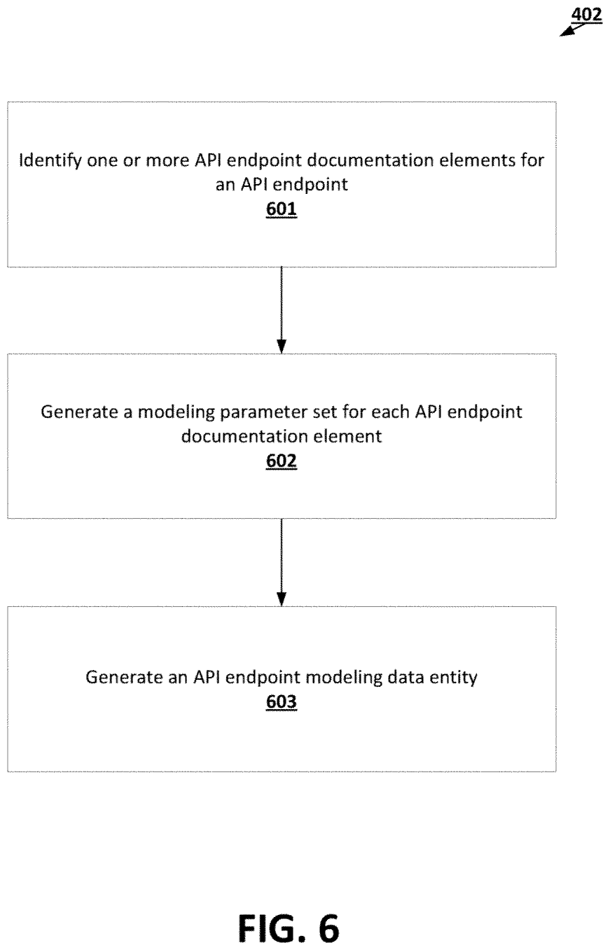

In some embodiments, step/operation 402 can be performed in accordance with the process that is depicted in FIG. 6, which is an example process for generating an API endpoint model data entity for a particular API endpoint. The process that is depicted in FIG. 6 begins at step/operation 601 when the web server computing entity 104 identifies one or more API endpoint documentation elements for the particular API endpoint. In some embodiments, the web server computing entity 104 retrieves the API endpoint documentation elements for the particular API endpoint based at least in part on the API design data entity for the API that is associated with the API endpoint. As noted above, in some embodiments, the web server computing entity 104 aggregates the API endpoint documentation elements for each API endpoint to generate the API design computing entity 104. In some embodiments, the API design data entity is a structured document entity that describes associations between defined API endpoints and API endpoint documentation elements. In some embodiments, the API design document entity is a JSON data entity.

At step/operation 602, the web server computing entity 104 generates, for each API endpoint documentation element, a model parameter set comprising one or more modeling parameters for the API documentation element. In some embodiments, the modeling parameter set for a particular API endpoint documentation element comprise one or more constraint parameters for the particular API endpoint documentation element that define one or more constraints for a user-entered value set for the particular API endpoint documentation element. Examples of model parameters include data type parameters, entry type parameters, minimum length parameters, maximum length parameters, default value parameters, help text parameters, hide-out parameters, null value allowance parameters, requirement parameters, and/or the like. In some embodiments, model parameters for various API endpoint documentation elements of an API endpoint are defined by an end user via interacting with a set of API modeling user interfaces.

In general, a modeling parameter may be a property of an API endpoint documentation element that defines the scope and manner of user entry of a value corresponding to an API endpoint documentation element when generating an automated testing workflow data entity for the corresponding API endpoint. For example, a requirement modeling parameter for an API documentation element may describe whether the end user is required to enter a value corresponding to an associated API endpoint documentation element when generating an automated testing workflow data entity for the corresponding API endpoint. Accordingly, in at least some embodiments, if an API endpoint documentation element is associated with an affirmative requirement parameter, the end user is required to enter a value corresponding to the API endpoint documentation element when generating an automated testing workflow data entity for the corresponding API endpoint, while a negative requirement parameter may indicate that the end user is not required to enter a value corresponding to the API endpoint documentation element when generating an automated testing workflow data entity for the corresponding API endpoint. As another example, a hide-out modeling parameter for an API documentation element may describe whether the end user is allowed to in access (e.g., either view data related to, or modify data related to, or both) a corresponding API endpoint documentation element when generating an automated testing workflow data entity for the corresponding API endpoint. Accordingly, in at least some embodiments, if an API endpoint documentation element is associated with an affirmative hide-out parameter, the end user is not allowed to access the API endpoint documentation element when generating an automated testing workflow data entity for the corresponding API endpoint, while a negative hide-out parameter may indicate that the end user is allowed access the API endpoint documentation element when generating an automated testing workflow data entity for the corresponding API endpoint. Other examples of modeling parameter include constraint parameters, data type parameter, entry type parameters, minimum value parameters, maximum value parameters, and null value allowance parameters. In some embodiments, the set of one or more modeling parameters for an API endpoint documentation element is referred to herein as a modeling parameter set for the API endpoint documentation element.

An example of a modeling parameter is a constraint parameter, which may be a modeling parameter that defines allowed formats for a user-entered value set for a corresponding API endpoint documentation element, where the user-entered value set for an API endpoint documentation element describes user values presented as inputs and/or expected values for the API endpoint documentation element when generating an automated testing workflow data entity. Examples of constraint parameters include a data type parameter that describes the format of the data (e.g., string, datetime, integer, and/or the like) that an end user is allowed to enter for a corresponding API endpoint documentation element, an entry type parameter that describes a method of entry of data that an end user is allowed to use for a corresponding API endpoint documentation element, a maximum length parameter that describes a maximum length of the data that an end user is allowed to enter for a corresponding API endpoint documentation element, a minimum length parameter that describes a maximum length of the data that an end user is allowed to enter for a corresponding API endpoint documentation element, a pattern parameter that describes an overall alphanumeric pattern of the data that an end user is allowed to enter for a corresponding API endpoint documentation element, and a null value allowance parameter that describes whether an end user is allowed to enter null-valued data a maximum length parameter that describes a maximum length of the data that an end user is allowed to enter for a corresponding API endpoint documentation element.

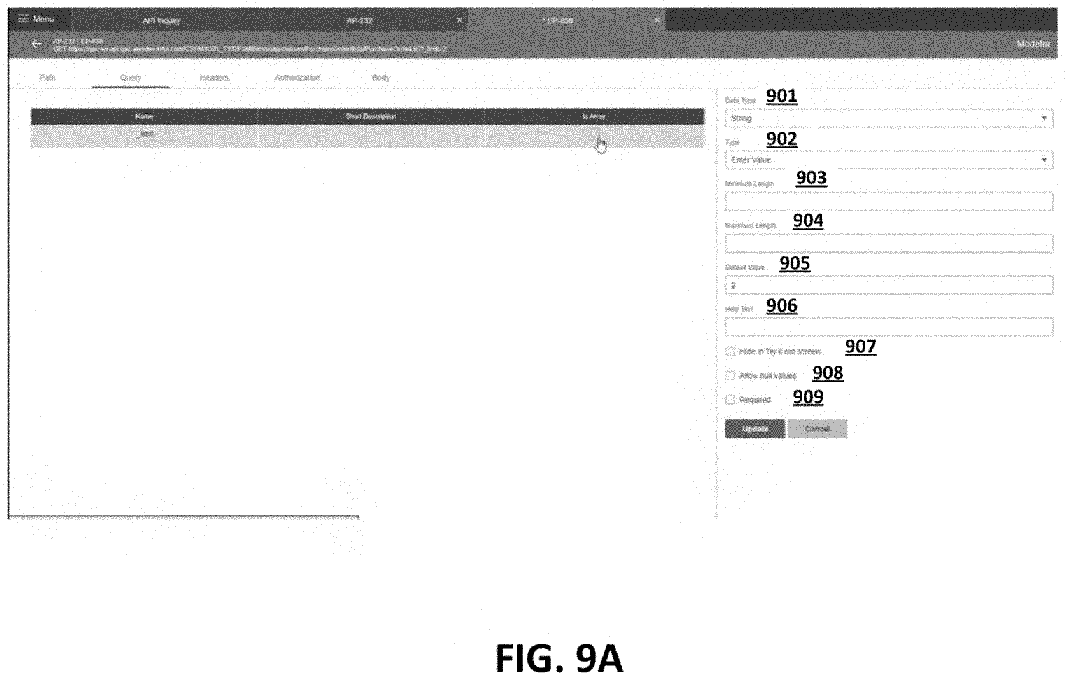

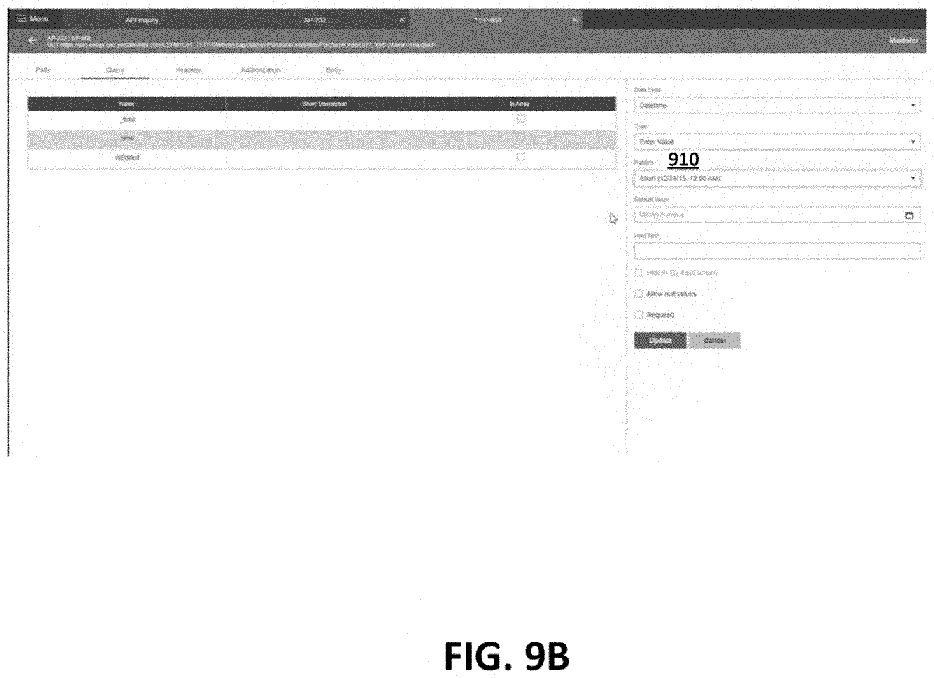

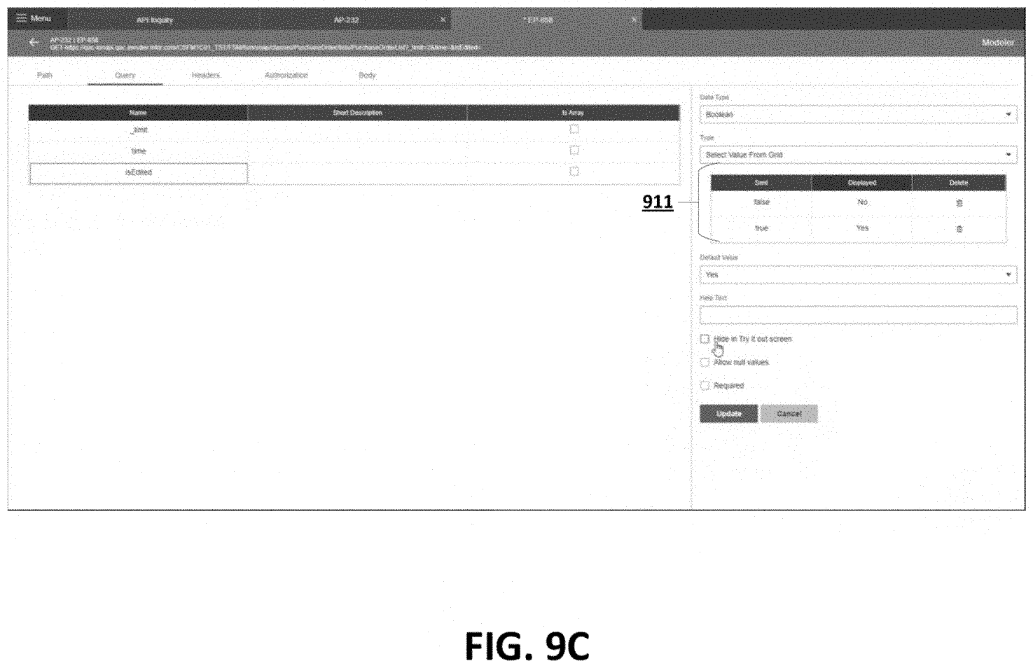

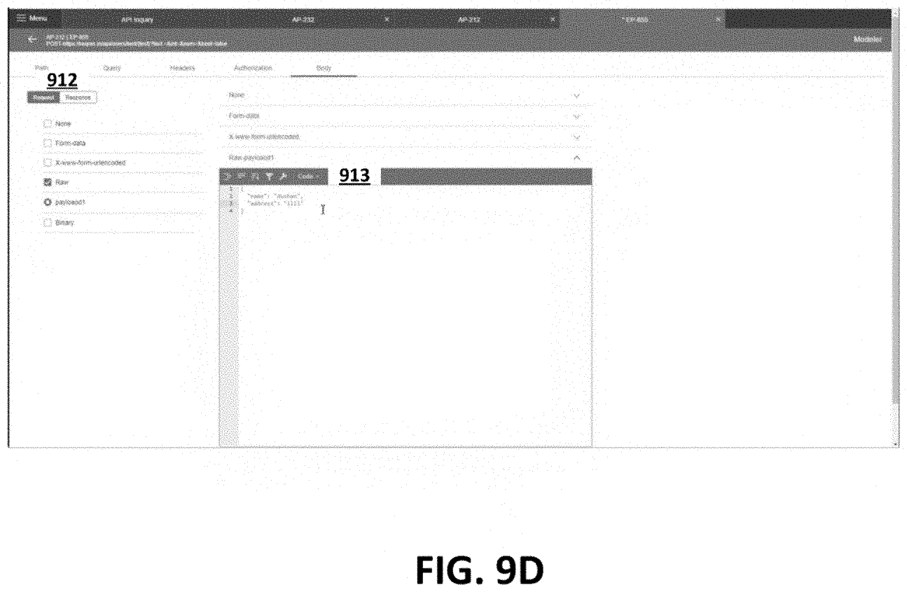

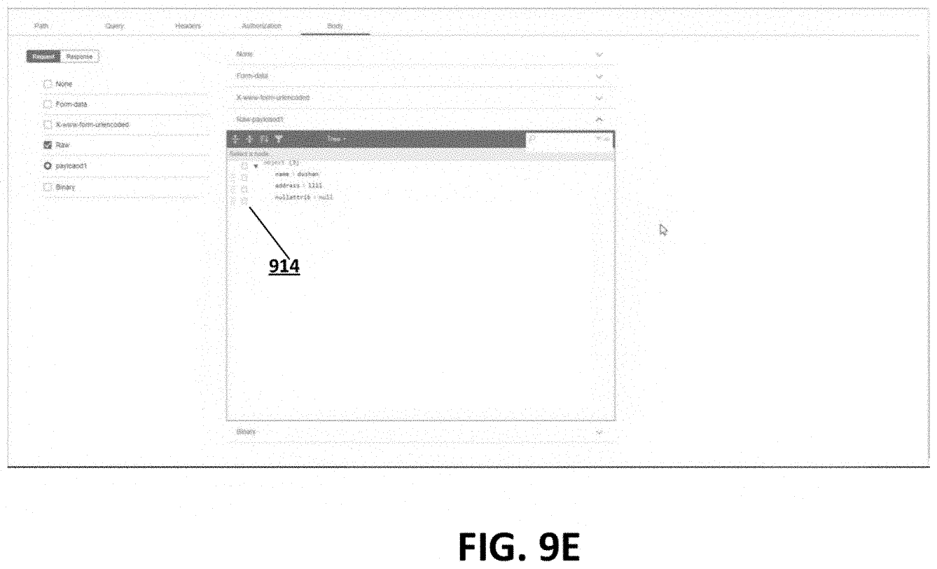

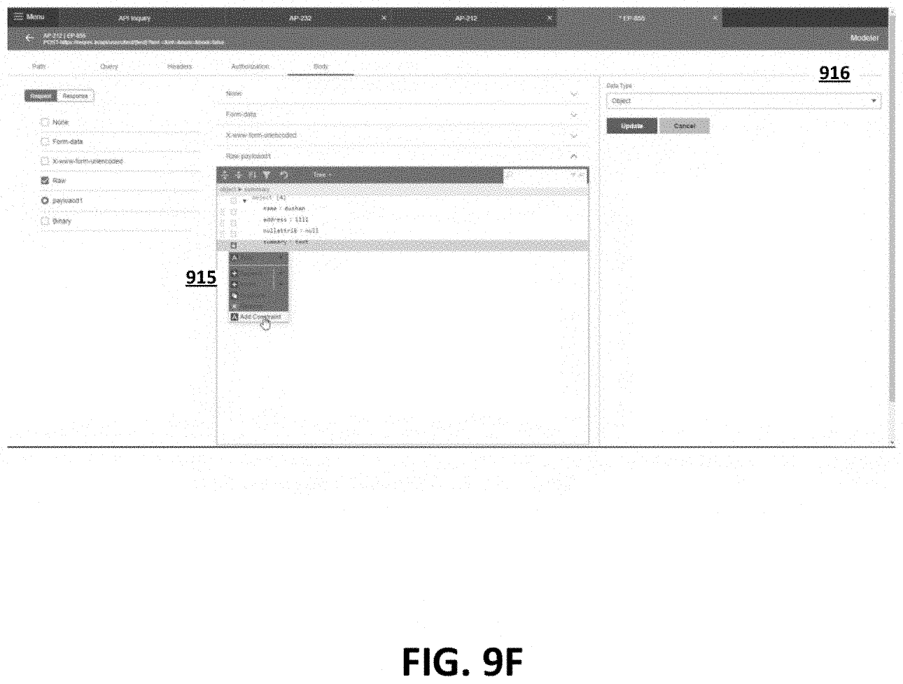

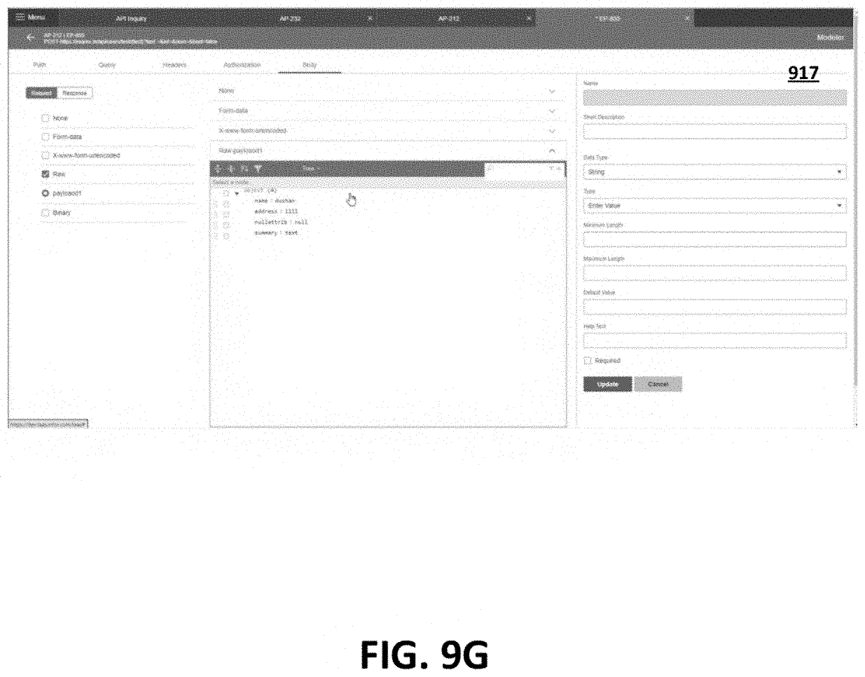

An operational example of a set of API endpoint documentation elements that can be used to define model parameters for various API endpoint documentation elements of an API endpoint is depicted in FIGS. 9A-9G. For example, the user interface of FIG. 9A enables defining the following model parameters for an API endpoint documentation element that is a query parameter, has a string data type parameter, and a value entry type parameter: (i) a data type parameter that defines a data format of the expected user-provided input of the corresponding API endpoint documentation element which may be provided using a set of workflow design user interfaces for the API endpoint, where the data type parameter may be provided/modified using the user interface element 901; (ii) an entry type parameter that defines an input method (e.g., entry through entering as text, entry through selection using a grid, entry through selection using a table, and/or the like) of the expected user-provided input of the corresponding API endpoint documentation element which may be provided using a set of workflow design user interfaces for the API endpoint, where the entry type parameter may be provided/modified using the user interface element 902; (iii) a minimum length parameter that describes a minimum number of characters in the expected user-provided input of the corresponding API endpoint documentation element which may be provided using a set of workflow design user interfaces for the API endpoint, where the minimum length parameter may be provided/modified using the user interface element 903; (iv) a maximum length parameter that describes a maximum number of characters in the expected user-provided input of the corresponding API endpoint documentation element which may be provided using a set of workflow design user interfaces for the API endpoint, where the maximum length parameter may be provided/modified using the user interface element 904; (v) a default value parameter that describes an input value that will be provided in the absence of any user-provided inputs which may be provided using a set of workflow design user interfaces for the API endpoint, where the default value parameter may be provided/modified using the user interface element 905; (vi) a help text parameter that describes data presented to the end user when the user is presented with a set of workflow design user interfaces that enable the user to provide one or more input values corresponding to the query parameter, where the help text parameter may be provided/modified using the user interface element 906; (vii) a hide-out parameter that describes whether the end user will be presented any data related to the query parameter via the set of workflow design user interfaces for the API endpoint and whether the set of workflow design user interfaces for the API endpoint enable the end user to provide any input data corresponding to the query parameter, where the help text parameter may be provided/modified using the user interface element 907; (viii) a null value allowance parameter that describes whether the end user will be permitted to provide null value data for to the query parameter, where the null value allowance parameter may be provided/modified using the user interface element 908; and (ix) a requirement parameter that describes whether the set of workflow design user interfaces for the API endpoint will require input of valid data corresponding to the query parameter, where the requirement parameter may be provided/modified using the user interface element 909.

As another example, the user interface of FIG. 9B enables defining a set of model parameters for an API endpoint documentation element that is a query parameter, has a datetime data type parameter, and a value entry type parameter, where the set of model parameters include a datetime pattern parameter that describes an expected format of datetime input data provided by an end user for the API endpoint documentation element using a set of workflow design user interfaces for the API endpoint. As depicted in FIG. 9B, the datetime pattern parameter may be provided/modified using the user interface element 910.

As yet another example, the user interface of FIG. 9C enables defining a set of model parameters for an API endpoint documentation element that is a query parameter, has a datetime data type parameter, and a value entry type parameter, where the set of model parameters include a set of grid option definition parameters enabling selecting a displayed value option from a grid and mapping a set of displayed values of the grid to a set of system-level-defined values. As depicted in FIG. 9C, the set of grid option definition parameters may be provided/modified using the user interface element 911.

As an additional example, the user interfaces of FIGS. 9D-9E enables defining a set of body parameters for either API endpoint request body or API endpoint response body either in the code structure of FIG. 9D or in the tree structure of FIG. 9E, where selection of the API endpoint request body or the API endpoint response body can be performed using the user interface element 912, and where selection of the code structure or the tree structure of the user interface element 913. As depicted in FIG. 9E, user selection of the user interface element 914 causes display of the user interface element 915 of FIG. 9F, which enables selecting the data type of a body parameter using the Type option of the user interface element 915 and the user interface element 916 of FIG. 9F. Moreover, user selection of the Add Constraint option of the user interface element 915 causes defining the following model parameters for a selected body parameter (e.g., using user interface elements such as the user interface element 917 of FIG. 9G): the data type parameter, the entry type parameter, the minimum length parameter, the maximum length parameter, the default value parameter, the help text parameter, and the requirement parameter.

Returning to FIG. 6, at step/operation 603, the web server computing entity 104 generates an API endpoint model data entity for the particular API endpoint model data entity that describes, for each API endpoint documentation element, the model parameter set for the API endpoint documentation element. In some embodiments, the API design data entity is a structured document entity that describes associations between defined API endpoint documentation elements and corresponding model parameter sets. In some embodiments, the API design document entity is a JSON data entity.

In some embodiments, an API endpoint model data entity describes, for each API endpoint documentation element of a corresponding API endpoint, a modeling parameter set. In some embodiments, the API endpoint model data entity defines a hidden subset of the plurality of API endpoint documentation elements, wherein each API endpoint documentation element in the hidden subset is associated with a modeling parameter set comprising an affirmative hide-out parameter. In some embodiments, the API endpoint model data entity defines a required subset of the plurality of API endpoint documentation elements, wherein each API endpoint documentation element in the required subset is associated with a modeling parameter set comprising an affirmative requirement parameter.

In some embodiments, the API endpoint model data entity is used to enable user interaction with a set of workflow design user interfaces that enable an end user to provide user value sets, where the user value sets are in turn used to generate an automated testing workflow data entity for a corresponding API endpoint documentation element. In some embodiments, a web server computing entity generates user interface data for one or more workflow design user interfaces, wherein: (i) the one or more workflow design user interfaces describe, for each API documentation element in a defined subset of the plurality of API endpoint documentation elements, constraint guidance data describing the one or more constraints for the user-entered value set for the API endpoint documentation element, and (ii) the one or more workflow design user interfaces enable an end user to provide each user-entered value set for an API endpoint documentation element in the defined subset. In some of the noted embodiments, the one or more workflow design user interfaces enable an end user to provide each user-entered value set based at least in part on historical log data entries associated with a corresponding API endpoint documentation element. In some of the noted embodiments, the API endpoint model data entity defines a hidden subset of the plurality of API endpoint documentation elements, wherein each API endpoint documentation element in the hidden subset is associated with a modeling parameter set comprising an affirmative hide-out parameter; and the defined subset is determined based at least in part on the hidden subset. In some of the noted embodiments, the API endpoint model data entity defines a required subset of the plurality of API endpoint documentation elements, wherein each API endpoint documentation element in the required subset is associated with a modeling parameter set comprising an affirmative requirement parameter; and the one or more workflow design user interfaces require that the end-user provides each user-entered value set for an API endpoint documentation element in the required subset.

In some embodiments, one or more workflow design user interfaces enable an end user to provide each user-entered value set for an API endpoint documentation element based at least in part on historical log data entries associated with a corresponding API endpoint documentation element. For example, the one or more workflow design user interfaces may generate prompts displaying previously-entered user values for an API endpoint documentation element having a particular API endpoint documentation element, where an API endpoint documentation element may be associated with a particular set of values for a particular subset of the modeling parameter set for the API endpoint documentation elements (e.g., all API endpoint documentation elements having a string data type that are query parameters and that are not arrays may have the same API endpoint documentation element type). In the noted example, the one or more workflow design user interfaces may enable the end-user to select the previously-entered user values by interacting with the noted prompts. In some embodiments, generating the automated testing workflow data entity based at least in part on each user-entered value set comprises generating each automated testing workflow step of the automated testing workflow data entity based at least in part on a user-entered value in the user-entered value set.

In some embodiments, API model data entities enable techniques for decoupling API test modeling from generating automated testing workflow design for API testing. For example, various embodiments of the present invention enable generating API endpoint model data entities and using the API endpoint model data entities to generate workflow design user interfaces that in turn enable a user to provide user values sets needed to generate automated testing workflow data entities for API endpoints. Decoupling API test modeling from generating automated testing workflow design for API testing enables more targeted and more resilient API testing, as it enables a test planner to generate constraints for testing that are required to be obeyed as well as general instructions for testing that may be ignored/modified at runtime. In this way, decoupling API test modeling from generating automated testing workflow design for API testing gives an important degree of flexibility to test planners in integrating runtime limits/considerations when formulating how to approach API testing operations. The result is more resilient, more traceable, and more flexible API testing approaches that in turn leads to better API testing, which eliminates/reduces the need for repeat API testing operations through reducing the number of erroneous software testing operations.

Returning to FIG. 4, at step/operation 403, the web server computing entity 104 generates an automated testing workflow data entity for each API endpoint. In some embodiments, the automated testing workflow data entity describes a set of automated testing workflow steps that correspond to entry of user-defined values corresponding to API endpoint documentation elements of the API endpoint, where entry of user-defined values may be performed in accordance with the constraints parameters associated with the API endpoint documentation elements. In some embodiments, an automated testing workflow data entity for an API endpoint may be generated using a set of workflow design user interfaces for the API endpoint.

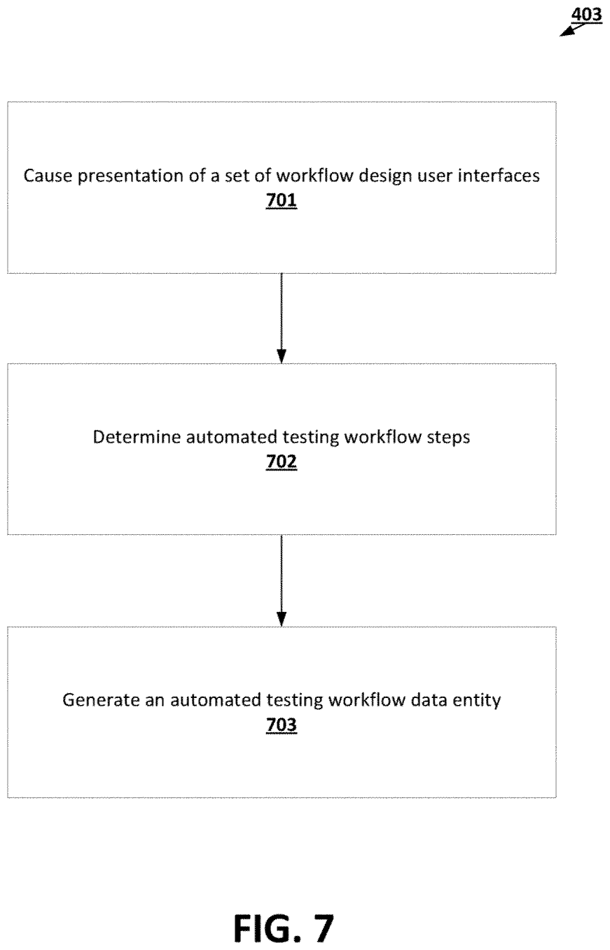

In some embodiments, step/operation 403 may be performed in accordance with the process that is depicted in FIG. 7, which is an example process for generating an automated testing workflow data entity for an API endpoint based at least in part on an API endpoint model data entity for the API endpoint. The process that is depicted in FIG. 7 begins at step/operation 701 when the web server computing entity 104 causes presentation (e.g., using a client computing entity) of a set of workflow design user interfaces. In some embodiments, the web server computing entity 104 generates user interface data for a set of workflow design user interfaces that are transmitted to a computing entity that is configured to display the set of workflow design user interfaces to an end user of the computing entity based at least in part on the user interface data.

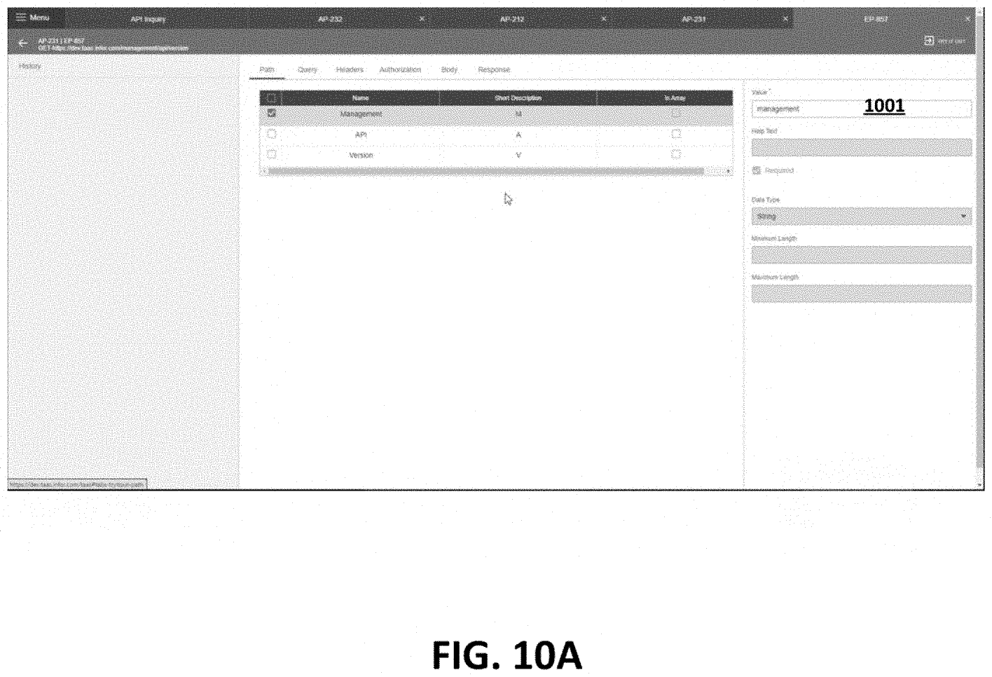

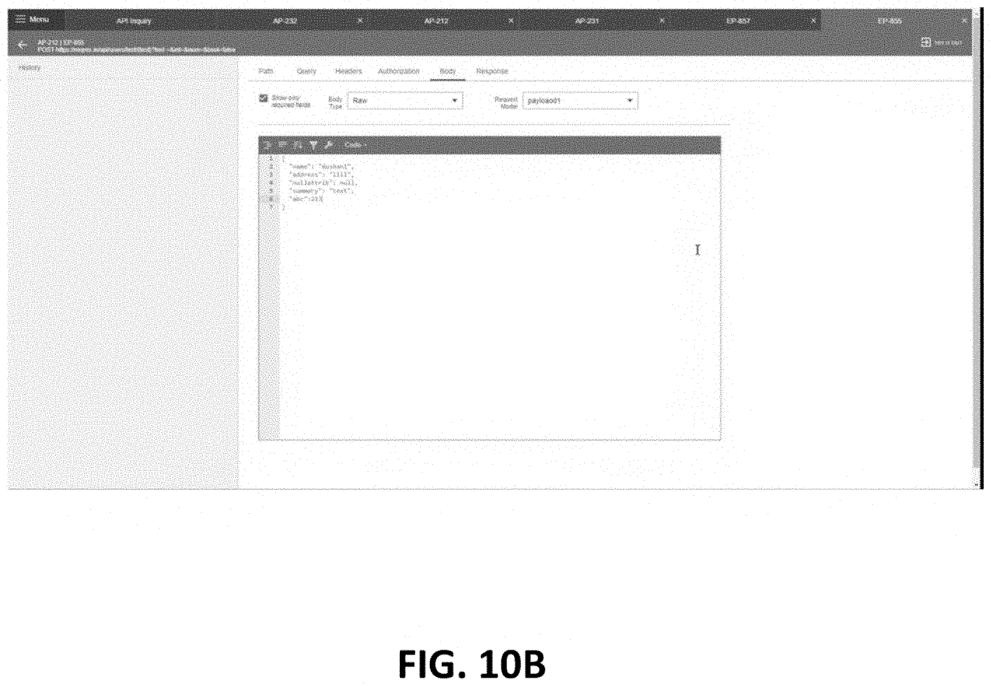

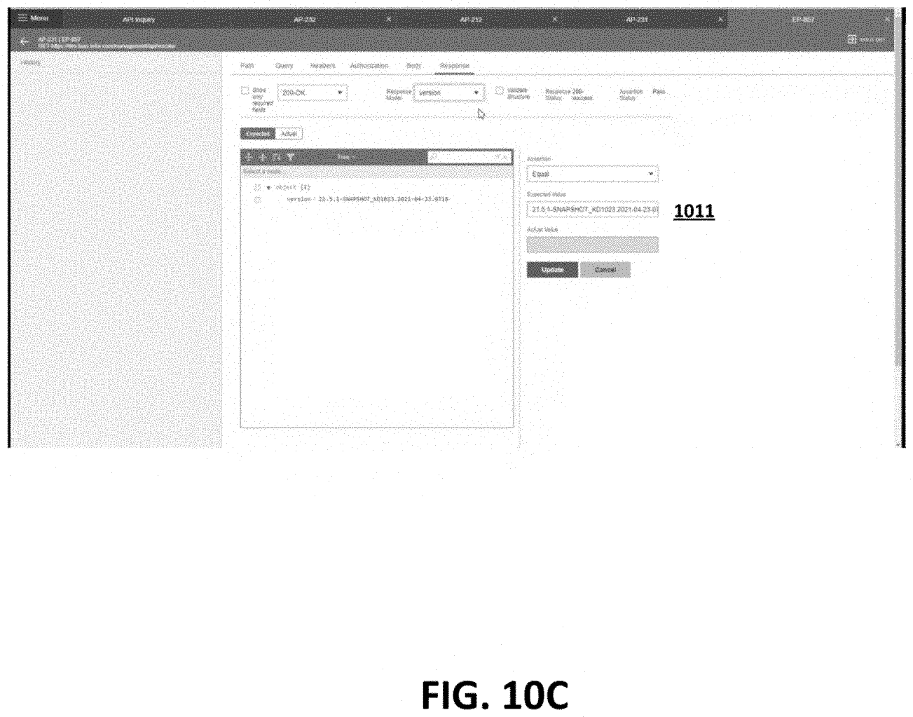

An operational example of a set of workflow design user interfaces that may be used to generate an automated testing workflow data entity for an API endpoint is depicted in FIGS. 10A-10C. For example, the user interface of FIG. 10A displays (as read-only fields), for each API endpoint documentation element that is a path parameter, the help text parameter, the requirement parameter, the maximum length parameter, and the minimum length parameter. The user interface of FIG. 10A further enables an end user to provide a value for the path parameter using the user interface element 1001.

As another example, the user interface of FIG. 10B enables the end user to provide values for API endpoint documentation elements that are request body parameters. For example, as depicted in FIG. 10B, the end user has provided the value of “dushan1” for the name request body parameter.

As yet another example, the user interface of FIG. 10C enables the end user to define expected values for API endpoint documentation elements that are response parameters. For example, as depicted in FIG. 10C, the end user has defined an expected value noted in user interface element 1011 for the version response parameter. In some embodiments, the combination of providing values for non-response parameters (e.g., response parameters) and response parameters enables negative testing, for example by setting a non-compliant value for a request parameter and putting the expected value of a response parameter to the expected value of an error response. In an exemplary, an end user can provide a non-compliant value for a body parameter that violates constraints for the body parameter, and then test to see if the API response returns an error code.

At step/operation 702, the web server computing entity 104 determines one or more automated workflow steps based at least in part on the user inputs that are provided to the set of workflow design user interfaces. In some embodiments, each user input value set provided as an input for an API endpoint documentation element is used to generate an automated testing workflow step, such as each automated testing workflow step corresponds to an API endpoint documentation element of the set of API endpoint documentation elements of the particular API endpoint.

At step/operation 703, the web server computing entity 104 determines the automated testing workflow data entity based at least in part on the one or more automated workflow steps. In some embodiments, the web server computing entity 104 aggregates the one or more automated workflow steps to generate the automated testing workflow data entity. In some embodiments, the web server computing entity 104 generates a JSON file that describes, for each automated testing workflow step, the user input value set for the corresponding API endpoint documentation element that is associated with the automated testing workflow step and optionally the user interface element that is associated with the automated testing workflow step.

In some embodiments, an automated testing workflow data entity describes a sequence of web-based actions that may be executed to generate an automated testing operation associated with a software test that is configured to be executed to achieve a particular software testing objective, such as to exercise a particular program path or to verify compliance with a specific operational requirement. For example, the automated testing workflow data entity may describe a sequence of webpages (e.g., a sequence of webpages from multiple websites across multiple tabs with one or more sessions) associated with a software testing operation, where each webpage may in turn be associated with a set of automated testing workflow steps. The sequence of webpages and their associated automated testing workflow steps may then be used to generate automation scripts for the software testing operation, where the automation script may be executed by an execution agent in order to execute the software testing operation and generate a software testing output based at least in part on a result of the execution of the automation script. In some embodiments, an automates testing workflow data entity describes a series of API endpoint calls that may be used to test an API.

In some embodiments, to generate an automated testing workflow data entity, a web server computing entity generates user interface data for one or more workflow design user interfaces, wherein: (i) the one or more workflow design user interfaces describe, for each API documentation element in a defined subset of the plurality of API endpoint documentation elements, constraint guidance data describing the one or more constraints for the user-entered value set for the API endpoint documentation element, and (ii) the one or more workflow design user interfaces enable an end user to provide each user-entered value set for an API endpoint documentation element in the defined subset. In some of the noted embodiments, the one or more workflow design user interfaces enable an end user to provide each user-entered value set based at least in part on historical log data entries associated with a corresponding API endpoint documentation element. In some of the noted embodiments, the API endpoint model data entity defines a hidden subset of the plurality of API endpoint documentation elements, wherein each API endpoint documentation element in the hidden subset is associated with a modeling parameter set comprising an affirmative hide-out parameter; and the defined subset is determined based at least in part on the hidden subset. In some of the noted embodiments, the API endpoint model data entity defines a required subset of the plurality of API endpoint documentation elements, wherein each API endpoint documentation element in the required subset is associated with a modeling parameter set comprising an affirmative requirement parameter; and the one or more workflow design user interfaces require that the end-user provides each user-entered value set for an API endpoint documentation element in the required subset. In some embodiments, generating the automated testing workflow data entity based at least in part on each user-entered value set comprises generating each automated testing workflow step of the automated testing workflow data entity based at least in part on a user-entered value in the user-entered value set. In some embodiments, automated execution of an automated testing workflow data entity is performed using at least one of an execution plan data entity and an execution run data entity.

At step/operation 404, the web server computing entity 104 access to the automated testing workflow data entity, wherein the automated testing workflow data entity enables performance of one or more software testing operations with respect to the API. In some embodiments, the web server computing entity 104 performs one or more software testing operations with respect to the API by using an execution plan data entity and an execution run data entity.

In some embodiments, step/operation 404 provides techniques for decoupling API test modeling from generating automated testing workflow design for API testing. For example, various embodiments of the present invention enable generating API endpoint model data entities and using the API endpoint model data entities to generate workflow design user interfaces that in turn enable a user to provide user values sets needed to generate automated testing workflow data entities for API endpoints. Decoupling API test modeling from generating automated testing workflow design for API testing enables more targeted and more resilient API testing, as it enables a test planner to generate constraints for testing that are required to be obeyed as well as general instructions for testing that may be ignored/modified at runtime. In this way, decoupling API test modeling from generating automated testing workflow design for API testing gives an important degree of flexibility to test planners in integrating runtime limits/considerations when formulating how to approach API testing operations. The result is more resilient, more traceable, and more flexible API testing approaches that in turn leads to better API testing, which eliminates/reduces the need for repeat API testing operations through reducing the number of erroneous software testing operations.

In some embodiments, an execution plan data entity is configured to describe a collection of API endpoint model data entities. For example, an execution plan data entity may describe a set of API endpoint model data entities that are generated based at least in part on a set of execution plan definition tags. In some embodiments, when an execution plan data entity is determined based at least in part on a set of API endpoint model data entities that are generated based at least in part on set of execution plan definition tags, the execution plan data entity may be referred to herein as a “dynamic execution plan data entity.” As another example, an execution plan data entity may describe a set of API endpoint model data entities that are explicitly selected by an end user of a web server computing entity. In some embodiments, when an execution plan data entity describes a set of API endpoint model data entities that are explicitly selected by an end user of a web server computing entity, the execution plan data entity may be referred to herein as a “static execution plan data entity.”

In some embodiments, an execution run data entity describes a defined execution of an execution plan data entity, such as a defined automated execution of an execution plan data entity or a defined manual execution of an execution plan data entity. In some embodiments, when an execution run data entity describes an automated execution of an execution plan data entity, the execution run data entity is referred to herein as an “automated execution run data entity.” In some embodiments, when an execution run data entity describes a manual execution of an execution plan data entity, the execution run data entity is referred to herein as a “manual execution run data entity.” In some embodiments, an execution run data entity is determined based at least in part on a set of execution run definition parameters for the execution run data entity, such as an execution run automation parameter for the execution run data entity that describes whether the execution run data entity is an automated execution run data entity or a manual execution run data entity; an execution run scheduling parameter for the execution run data entity that describes whether the execution run data entity should be executed once, periodically (e.g., in accordance with a defined periodicity), or in an on-demand manner as demanded by end users; an execution run parallelization parameter for the execution run data entity that describes whether the execution run data entity should be performed sequentially or in parallel; and an execution run web environment parameter for the execution run data entity that describes the Uniform Resource Locator (URL) for a base (i.e., starting) webpage of the execution run data entity.

Thus, as described above, by reducing the number of erroneous testing operations by decoupling API test modeling from generating automated testing workflow design for API testing, various embodiments of the present invention improve the operational efficiency of test automation platforms by reducing the number of processing operations that need to be executed by the noted test automation platforms in order to enable software testing operations (e.g., automated software testing operations). By reducing the number of processing operations that need to be executed by the noted test automation platforms in order to execute software testing operations, various embodiments of the present invention make important technical contributions to the field of software application testing. Accordingly, by enhancing the accuracy and reliability of automated testing workflow data entities generated by software testing engineers, the user-friendly and intuitive automated testing workflow generation techniques described herein improve the operational reliability of software application frameworks that are validated using the improved software testing operations described herein. By enhancing the operational reliability of software application frameworks that are validated using the improved software testing operations described herein, various embodiments of the present invention make important technical contributions to the field of software application framework.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for enabling automated testing of an application programming interface (API) endpoint of an API, the computer-implemented method comprising:
identifying, by a processor, an API endpoint model data entity for the API endpoint;
generating, by the processor, user interface data for one or more workflow design user interfaces, wherein: (i) the one or more workflow design user interfaces describe, for each API documentation element in a defined subset of the plurality of API endpoint documentation elements, constraint guidance data describing one or more constraints for a user-entered value set for the API endpoint documentation element, and (ii) the one or more workflow design user interfaces enable an end user to provide each user-entered value set for an API endpoint documentation element in the defined subset;
generating, by the processor, the automated testing workflow data entity based at least in part on each user-entered value set; and
providing, by the processor, access to the automated testing workflow data entity, wherein the automated testing workflow data entity enables performance of one or more software testing operations.

2. The computer-implemented method of claim 1, wherein generating the automated testing workflow data entity based at least in part on each user-entered value set comprises generating each automated testing workflow step for the automated testing workflow data entity based at least in part on a user-entered value in the user-entered value set.

3. The computer-implemented method of claim 1, wherein generating the automated testing workflow data entity comprises generating one or more automated testing workflow steps for the automated testing workflow data entity based at least in part on each user-entered value set for an API endpoint documentation element in the defined subset.

4. The computer-implemented method of claim 1, wherein the API endpoint model data entity is generated based at least in part on an imported API documentation data entity for the API.

5. The computer-implemented method of claim 1, wherein:
the API endpoint model data entity defines a hidden subset of the plurality of API endpoint documentation elements, wherein each API endpoint documentation element in the hidden subset is associated with a modeling parameter set comprising an affirmative hide-out parameter; and
the defined subset is determined based at least in part on the hidden subset.

6. The computer-implemented method of claim 1, wherein:
the API endpoint model data entity defines a required subset of the plurality of API endpoint documentation elements, wherein each API endpoint documentation element in the required subset is associated with a modeling parameter set comprising an affirmative requirement parameter; and
the one or more workflow design user interfaces require that the end-user provides each user-entered value set for an API endpoint documentation element in the required subset.

7. The computer-implemented method of claim 1, wherein the one or more workflow design user interfaces enable an end user to provide each user-entered value set based at least in part on historical log data entries associated with a corresponding API endpoint documentation element.

8. An apparatus enabling automated testing of an application programming interface (API) endpoint of an API, the apparatus comprising at least one processor and at least one memory including program code, the at least one memory and the program code configured to, with the processor, cause the apparatus to at least:
identify an API endpoint model data entity for the API endpoint;
generate user interface data for one or more workflow design user interfaces, wherein: (i) the one or more workflow design user interfaces describe, for each API documentation element in a defined subset of the plurality of API endpoint documentation elements, constraint guidance data describing one or more constraints for a user-entered value set for the API endpoint documentation element, and (ii) the one or more workflow design user interfaces enable an end user to provide each user-entered value set for an API endpoint documentation element in the defined subset;
generate the automated testing workflow data entity based at least in part on each user-entered value set; and
provide access to the automated testing workflow data entity, wherein the automated testing workflow data entity enables performance of one or more software testing operations.

9. The apparatus of claim 8, wherein generating the automated testing workflow data entity based at least in part on each user-entered value set comprises generating each automated testing workflow step for the automated testing workflow data entity based at least in part on a user-entered value in the user-entered value set.

10. The apparatus of claim 8, wherein generating the automated testing workflow data entity comprises generating one or more automated testing workflow steps for the automated testing workflow data entity based at least in part on each user-entered value set for an API endpoint documentation element in the defined subset.

11. The apparatus of claim 8, the API endpoint model data entity is generated based at least in part on an imported API documentation data entity for the API.

12. The apparatus of claim 8, wherein:
the API endpoint model data entity defines a hidden subset of the plurality of API endpoint documentation elements, wherein each API endpoint documentation element in the hidden subset is associated with a modeling parameter set comprising an affirmative hide-out parameter; and
the defined subset is determined based at least in part on the hidden subset.

13. The apparatus of claim 8, wherein:
the API endpoint model data entity defines a required subset of the plurality of API endpoint documentation elements, wherein each API endpoint documentation element in the required subset is associated with a modeling parameter set comprising an affirmative requirement parameter; and
the one or more workflow design user interfaces require that the end-user provides each user-entered value set for an API endpoint documentation element in the required subset.

14. The apparatus of claim 8, wherein the one or more workflow design user interfaces enable an end user to provide each user-entered value set based at least in part on historical log data entries associated with a corresponding API endpoint documentation element.

15. A computer program product for enabling automated testing of an application programming interface (API) endpoint of an API, the computer-implemented method comprising, the computer program product comprising at least one non-transitory computer-readable storage medium having computer-readable program code portions stored therein, the computer-readable program code portions configured to:
identify an API endpoint model data entity for the API endpoint;
generate user interface data for one or more workflow design user interfaces, wherein: (i) the one or more workflow design user interfaces describe, for each API documentation element in a defined subset of the plurality of API endpoint documentation elements, constraint guidance data describing one or more constraints for a user-entered value set for the API endpoint documentation element, and (ii) the one or more workflow design user interfaces enable an end user to provide each user-entered value set for an API endpoint documentation element in the defined subset;
generate the automated testing workflow data entity based at least in part on each user-entered value set; and
provide access to the automated testing workflow data entity, wherein the automated testing workflow data entity enables performance of one or more software testing operations.

16. The computer program product of claim 15, wherein generating the automated testing workflow data entity based at least in part on each user-entered value set comprises generating each automated testing workflow step for the automated testing workflow data entity based at least in part on a user-entered value in the user-entered value set.

17. The computer program product of claim 15, wherein generating the automated testing workflow data entity comprises generating one or more automated testing workflow steps for the automated testing workflow data entity based at least in part on each user-entered value set for an API endpoint documentation element in the defined subset.

18. The computer program product of claim 15, the API endpoint model data entity is generated based at least in part on an imported API documentation data entity for the API.

19. The computer program product of claim 15, wherein:
the API endpoint model data entity defines a hidden subset of the plurality of API endpoint documentation elements, wherein each API endpoint documentation element in the hidden subset is associated with a modeling parameter set comprising an affirmative hide-out parameter; and
the defined subset is determined based at least in part on the hidden subset.

20. The computer program product of claim 15, wherein:
the API endpoint model data entity defines a required subset of the plurality of API endpoint documentation elements, wherein each API endpoint documentation element in the required subset is associated with a modeling parameter set comprising an affirmative requirement parameter; and
the one or more workflow design user interfaces require that the end-user provides each user-entered value set for an API endpoint documentation element in the required subset.
